(19) United States
(12) Patent Application Publication
(10) Pub. No.: US 2026/0139508 A1
(43) Pub. Date: May 21, 2026

(54) FLAGPOLE ADAPTER

(71) Applicant: AVIRAM.F INDUSTRIES LTD, Balfouria (IL)

(72) Inventor: Aviram FROST, Moshav Balfuria (IL)

(21) Appl. No.: 19/274,894

(22) Filed: Jul. 21, 2025

(30) Foreign Application Priority Data
Nov. 19, 2024 (IL) 317187

(51) Int. Cl. E04H 12/22; E04H 12/32

(52) U.S. Cl. CPC E04H 12/2223; E04H 12/2284; E04H 12/32

(57) ABSTRACT

The present disclosure describes a flagpole adapter for interchangeable mounting between a flagpole end and a flagpole sleeve mount while enabling free rotation. The adapter comprises an adapter body having an adapter mouth dimensioned to receive the flagpole end and an adapter seat dimensioned for insertion into the flagpole sleeve mount. A rotation assembly integrated with the adapter body enables free rotation of the flagpole end relative to the adapter seat. The rotation assembly includes at least one pole-locking mechanism that is resiliently actuable to engage the flagpole end. The pole-locking mechanism comprises an inner lock edge defining a locking circumference configurable between a relaxed configuration having a relaxed diameter less than the flagpole diameter and an actuated configuration when engaging the flagpole end.

### CROSS REFERENCE TO RELATED APPLICATIONS

The present application claims benefit from Israeli Patent Application No. 317187 filed on Nov. 19, 2024, and is incorporated hereby by reference in its entirety.

### TECHNOLOGICAL FIELD

The presently disclosed subject matter generally relates to an adapter mechanism. More particularly, the presently disclosed subject matter relates to a flagpole adapter and kit for mounting to a flagpole for enabling rotation of the flagpole a main flagpole axis.

### GENERAL DESCRIPTION

There is provided in accordance with one aspect according to the presently disclosed subject matter a flagpole adapter for interchangeable mounting with a flagpole end of a flagpole, in a flagpole sleeve mount dimensioned to receive the flagpole end and rotatably supporting the flagpole therein. The flagpole adapter according to the presently disclosed subject matter comprises an adapter body and a rotation assembly. The adapter body comprises an adapter mouth dimensioned for receiving the flagpole end of the flagpole and an adapter seat dimensioned to be received in the flagpole sleeve mount. The rotation assembly is integratable with the adapter body and configured to enable free rotation of the flagpole end in the adapter mouth, with respect to the adapter seat, when the flagpole end is received in the adapter mouth.

As used herein, the term “free rotation” (also referred to as “passive rotation”) means rotation of the flagpole about its longitudinal axis enabled by a bearing mechanism without any active driving means, such that the flagpole can rotate in response to external forces such as wind or manual manipulation.

The term “integratable” as used herein means capable of being assembled together to form an operational unit, specifically referring to components that can be mechanically coupled either permanently or detachably.

For purposes of the present disclosure, standardized flagpoles typically have outer diameters of between 1 inch (25.4 mm) and 3 inches (76.2 mm), most commonly either 1 inch (25.4 mm) or 2 inches (50.8 mm). The adapter seat of the presently disclosed flagpole adapter can have an outer diameter corresponding to these standard flagpole dimensions to enable interchangeable mounting in conventional flagpole sleeve mounts designed for such standardized flagpoles.

In some embodiments, the flagpole has a transverse pole cross section equal to the transverse seat cross section. In some embodiments, the adapter seat is cylindrical. In some embodiments, the rotation assembly is disposed within the adapter mouth and configured to coaxially align the main flagpole axis with an axis of rotation defined by the rotation assembly. In some embodiments, the rotation assembly comprises an adapter having an adapter seat end and an adapter mouth end. The adapter seat end is positioned adjacent the adapter seat and the adapter mouth end is positioned adjacent the adapter mouth. In some embodiments, the adapter mouth end is configured to receive the flagpole end, which flagpole end is supportable by the adapter seat end.

In some embodiments, the rotation assembly comprises a bearing mechanism positioned intermediate the adapter body and the adapter configured to enable rotation of the adapter about the axis of rotation within the adapter body. In some embodiments, the adapter comprises a plurality of circumferentially spaced support portions extending in radial outer adjacency to the axis of rotation configured to radially engage and support the flagpole end. In some embodiments, the support portions extend from the adapter mouth end to the adapter seat end. In some embodiments, the support portions are integrally formed with the adapter seat end.

In some embodiments, the support portions each comprise an inner support surface. The inner support surfaces of the support portions are configured to support an outer pole surface of the flagpole end. In some embodiments, the outer pole surface of the flagpole end is circular, and the inner support surfaces are radiused to correspondingly mate with the outer pole surface. In some embodiments, the inner support surfaces each comprise a uniform radius. The uniform radii of the inner support surfaces equal a flagpole end radius extending transversely relative to the flagpole axis.

In some embodiments, the adapter comprises at least one pole-locking mechanism. In some embodiments, the adapter comprises a plurality of circumferentially spaced pole-locking mechanisms. In some embodiments, the pole-locking mechanisms are alternatingly positioned intermediate the circumferentially spaced support portions. In some embodiments, at least one pole-locking mechanism is resiliently actuable to resiliently engage the flagpole end for locking the flagpole end within the adapter.

In some embodiments, at least one pole-locking mechanism extends inwardly from an adapter wall of the adapter along a chord plane. In some embodiments, each pole-locking mechanism comprises an inner lock edge, which inner lock edges together define a locking circumference. In some embodiments, the locking circumference is configurable intermediate a relaxed configuration and an actuated configuration such that the relaxed configuration has a relaxed diameter less than a flagpole diameter of the flagpole end.

In some embodiments, the rotation assembly comprises a seat bearing and a mouth bearing. The seat bearing is positioned at the adapter seat end and the mouth bearing is positioned intermediate the adapter mouth end and the adapter mouth enabling rotation of the adapter relative to the adapter body. In some embodiments, the support portions each comprise an outer support surface, which outer support surfaces together define an outer support surface circumference matable with an inner bearing surface of at least one of the seat bearing and the mouth bearing.

In some embodiments, the adapter seat end comprises a plurality of circumferentially spaced seat supports. In some embodiments, each seat support comprises a radiused inner seat surface. The radiused inner seat surfaces define a seat aperture the diameter of which is less than the flagpole diameter. In some embodiments, each seat support comprises an upper seat surface, which upper seat surfaces are coplanar along a seat support plane. In some embodiments, the seat supports define adapter gaps therebetween.

In some embodiments, the seat supports are configured to both support the flagpole end and cooperate with the adapter gaps to enable seat resilience such that the support portions snugly receive and support the flagpole end. In some embodiments, the flagpole adapter may further comprise an annular adapter cap attachable to the adapter mouth for enclosing the adapter within the adapter body. The flagpole end is insertable into the adapter body via a cap aperture of the annular adapter cap in some embodiments.

There is provided in accordance with another aspect according to the presently disclosed subject matter a flagpole adapter kit for mounting a flagpole and enabling the flagpole as mounted to freely rotate about a flagpole axis. The flagpole adapter kit according the presently disclosed subject matter comprises a flagpole adapter and an adapter mounting mechanism.

In some embodiments, the adapter mounting mechanism is characterized by a wall mount and in some embodiments, the adapter mounting mechanism is characterized by a ground anchor. In some embodiments, the wall mount comprises a wall plate and a bracket assembly extending therefrom for positioning the flagpole sleeve mount relative to the wall plate. In some embodiments, the bracket assembly is adjustable for repositioning the flagpole sleeve mount relative to the wall plate. In some embodiments, the flagpole sleeve mount is pivotal about a pivot axis of rotation extending through the bracket assembly of the wall mount.

In some embodiments, the ground anchor comprises a spiral-shaped blade extending from a central shaft portion, which central shaft portion is conical in form and terminates in a ground-piercing point. In some embodiments, the ground-piercing point and the spiral-shaped blade extending from a central shaft portion enable a user to screw the ground anchor into a ground substrate thereby anchoring the flagpole sleeve mount at an anchor site. In some embodiments, the ground anchor comprises a divider plate portion. The divider plate portion is configured to provide a tool interface for enabling a torque tool to screw the ground anchor into the ground substrate.

### BRIEF DESCRIPTION OF THE DRAWINGS

Other features and objectives of the presently disclosed subject matter will become more evident from a consideration of the following brief descriptions of patent drawings.

FIG. 1A is a diagrammatic depiction of a flagpole with wind-directed flag mounted in a conventional mount showing the fly portion of the flag being wind-directed in a first direction.

FIG. 1B is a diagrammatic depiction of the flagpole and flag otherwise shown in FIG. 1A mounted in a flagpole adapter according to the presently disclosed subject matter showing the fly portion of the flag being wind-directed in the first direction.

FIG. 1C is a diagrammatic depiction of the flagpole and flag otherwise shown in FIG. 1B mounted in the flagpole adapter according to the presently disclosed subject matter showing rotation of the flagpole about a flagpole axis and the fly portion of the flag being wind-directed in a second direction opposite the first direction.

FIG. 2 is a top perspective view of the flagpole adapter according to the presently disclosed subject matter.

FIG. 3 is a side elevational view of the flagpole adapter according to the presently disclosed subject matter mounted to a flagpole end of a flagpole and depicting an axis of rotation defined by a rotation assembly of the flagpole adapter aligned with a main flagpole axis and a main adapter axis.

FIG. 3A is a first sequential diagrammatic depiction of the flagpole end of the flagpole being directed into a flagpole sleeve mount according to the presently disclosed subject matter.

FIG. 3B is a second sequential diagrammatic depiction of the flagpole end mounted in the flagpole sleeve mount according to the presently disclosed subject matter.

FIG. 3C is a third sequential diagrammatic depiction of the flagpole end of the flagpole being directed out of the flagpole sleeve mount according to the presently disclosed subject matter.

FIG. 3D is a fourth sequential diagrammatic depiction of an adapter seat of the flagpole adapter being directed into the flagpole sleeve mount according to the presently disclosed subject matter.

FIG. 3E is a fifth sequential diagrammatic depiction of the flagpole adapter mounted in the flagpole sleeve mount and the flagpole end of the flagpole being directed into the flagpole adapter according to the presently disclosed subject matter.

FIG. 3F is a sixth sequential diagrammatic depiction of the flagpole adapter mounted in the flagpole sleeve mount and the flagpole end of the flagpole mounted in the flagpole adapter showing rotation about the flagpole axis according to the presently disclosed subject matter.

FIG. 4 is an enlarged top plan view of the flagpole adapter according to the presently disclosed subject matter showing an open adapter mouth for receiving a flagpole end of a flagpole with a central axis of rotation extending out of the page.

FIG. 5A is an enlarged bottom plan view of a flagpole adapter according to the presently disclosed subject matter juxtaposed adjacent a flagpole showing a seat diameter of an adapter seat aligned with a flagpole diameter of the flagpole.

FIG. 5B is a transverse cross-sectional view of the adapter seat otherwise shown in FIG. 5A aligned with a first transverse cross-sectional view of the flagpole otherwise shown in FIG. 5A showing the seat diameter of the adapter seat equaling the flagpole diameter of the flagpole.

FIG. 6 is an exploded side view of the flagpole adapter according to the presently disclosed subject matter showing from top to bottom an adapter cap, a mouth bearing, an adapter, a seat bearing and an adapter body.

FIG. 7 is a first top perspective view of the adapter body according to the presently disclosed subject matter showing a first perspective of an adapter mouth of the adapter body.

FIG. 8 is a second top perspective view of the adapter body according to the presently disclosed subject matter showing a second perspective of the adapter mouth and a barrel bottom of the adapter body.

FIG. 9 is an enlarged top plan view of the adapter body according to the presently disclosed subject matter showing the adapter mouth, barrel bottom and a central main adapter axis of the adapter body.

FIG. 10 is a first top perspective view of a rotation assembly according to the presently disclosed subject matter showing a first perspective of an adapter mouth of the rotation assembly.

FIG. 11 is an exploded side view of the rotation assembly according to the presently disclosed subject matter showing from top to bottom the mouth bearing, the adapter and the seat bearing.

FIG. 12 is a top perspective view of the adapter according to the presently disclosed subject matter showing a perspective of the adapter mouth of the adapter.

FIG. 13 is a side elevational view of the adapter according to the presently disclosed subject matter.

FIG. 14 is a bottom perspective view of the adapter according to the presently disclosed subject matter showing a perspective of the adapter seat end of the adapter.

FIG. 15 is an enlarged top plan view of the adapter according to the presently disclosed subject matter showing a central axis of rotation defined by the adapter and an array of circumferentially spaced seat supports, pole support portions and pole-locking mechanisms in outer radial adjacency to the central axis of rotation.

FIG. 16 is a second transverse cross-sectional view of the flagpole presented next to FIG. 15 for ease of comparison and showing relative dimensional characteristics thereof that cooperate with the adapter.

FIG. 17 is an enlarged bottom plan view of the adapter according to the presently disclosed subject matter with a mounted flagpole end showing the central axis of rotation aligned with the main flagpole axis and the structural engagement of the array of circumferentially spaced seat supports, pole support portions and pole-locking mechanisms relative to the flagpole end.

FIG. 18A is an enlarged fragmentary sectional view of a pole-locking mechanism according to the presently disclosed subject matter shown in broken lining to depict a relaxed configuration relative to a fragmentary flagpole end received within the adapter.

FIG. 18B is an enlarged fragmentary sectional view of the pole-locking mechanism otherwise depicted in FIG. 18A shown in solid lining to depict an actuated configuration relative to the fragmentary flagpole end received within the adapter.

FIG. 19 is a top plan view of an annular seat/mouth bearing of the rotation assembly according to the presently disclosed subject matter.

FIG. 20 is an enlarged top perspective view of the annular seat/mouth bearing of the rotation assembly according to the presently disclosed subject matter.

FIG. 21 is an enlarged bottom perspective view of the annular seat/mouth bearing of the rotation assembly according to the presently disclosed subject matter.

FIG. 22 is a second top perspective view of the rotation assembly according to the presently disclosed subject matter showing a second perspective of the adapter mouth with adapter cap mounted thereto.

FIG. 23 is a longitudinal cross-sectional view of the rotation assembly according to the presently disclosed subject matter shown from a top perspective to show the adapter mouth end and the adapter seat end in perspective.

FIG. 24 is a longitudinal cross-sectional view of the rotation assembly otherwise depicted in FIG. 22 shown in side elevation to show the adapter mouth end and the adapter seat end of the adapter.

FIG. 25 is a longitudinal cross-sectional view of the adapter body according to the presently disclosed subject matter showing an upper barrel portion and a lower adapter seat extending from the barrel portion.

FIG. 26 is a longitudinal cross-sectional view of the flagpole adapter according to the presently disclosed subject matter showing the rotation assembly received within the barrel portion of the adapter body in upper adjacency to the lower adapter seat.

FIG. 27 is a longitudinal cross-sectional view of the flagpole adapter otherwise shown in FIG. 26 shown from a top perspective to show the adapter mouth end and the adapter seat end of the adapter in perspective relative to the adapter body.

FIG. 28A is a reduced top perspective of the flag adapter according to the presently disclosed subject matter.

FIG. 28B is a reduced top perspective of the flag adapter mounted to a ground anchor according to the presently disclosed subject matter and presented in side-by-side relation to FIG. 28A for ease of comparison.

FIG. 28C is a reduced top perspective of the flag adapter mounted to a wall anchor according to the presently disclosed subject matter and presented in side-by-side relation to FIGS. 28A and 28B for ease of comparison.

FIG. 29 is an enlarged top perspective view of the of the flag adapter mounted to the ground anchor otherwise shown in FIG. 28B enlarged to show in greater detail features thereof.

FIG. 30 is an enlarged top perspective view of the of the ground anchor according to the presently disclosed subject matter showing an upper flagpole sleeve mount in which the adapter seat of the adapter body is mounted, a lower screw portion and a divider plate portion extending between the flagpole sleeve mount and the lower screw portion.

FIG. 31 is an enlarged side elevational view of the ground anchor according to the presently disclosed subject matter.

FIG. 32 is an enlarged top plan view of the ground anchor according to the presently disclosed subject matter showing opposed parallel plate edges of the divider plate portion and locator notch formed at an inner surface of the flagpole sleeve mount.

FIG. 33 is an enlarged first top perspective view of the of the flag adapter mounted to the wall anchor otherwise shown in FIG. 28C enlarged to show in greater detail features thereof.

FIG. 34 is an enlarged second top perspective view of the of the flag adapter mounted to the wall anchor.

FIG. 35 is an enlarged second top perspective view of the of the wall anchor according to the presently disclosed subject matter showing female mount portion of the flagpole sleeve mount, a wall plate and an adjustable bracket assembly interconnecting the flagpole sleeve mount to the wall plate.

FIG. 36 is an enlarged axial view of the flagpole sleeve mount as connected to the wall plate via the bracket assembly in perspective depicting an inner diameter of the female mount portion.

FIG. 37 is an exploded perspective view of the wall anchor according to the presently disclosed subject matter showing from left to right the wall plate with a plate extension; the flagpole sleeve mount with a mount extension; and an adjustment knob with a pivot axis of rotation extending through the adjustment knob, the mount extension and the plate extension.

FIG. 38A is a first sequential side view of the wall anchor according to the presently disclosed subject matter showing the flagpole sleeve mount in a first oblique orientation relative to the wall plate before being pivoted about the pivot axis of rotation.

FIG. 38B is a second sequential side view of the wall anchor according to the presently disclosed subject matter showing the flagpole sleeve mount in a second oblique orientation relative to the wall plate after being pivoted about the pivot axis of rotation.

FIG. 39 is a diagrammatic depiction of a flagpole with wind-directed flag mounted in a conventional wall mount showing the fly portion of the flag being wind-directed in a first direction out of the page.

FIG. 40 is a diagrammatic depiction of a flagpole and a flag mounted in the flagpole adapter as mounted to the wall anchor adapter mounting mechanism in the first oblique orientation according to the presently disclosed subject matter and showing the fly portion of the flag being wind-directed in the first direction out of the page.

FIG. 41 is a diagrammatic depiction of the flagpole and flag otherwise shown in FIG. 40 mounted in the flagpole adapter according to the presently disclosed subject matter showing the fly portion of the flag being wind-directed in the first direction to the right of the page along an X axis.

FIG. 42 is a diagrammatic depiction of the flagpole and flag otherwise shown in FIGS. 40 and 41 mounted in the flagpole adapter according to the presently disclosed subject matter showing rotation of the flagpole about a flagpole axis and the fly portion of the flag being wind-directed in a second direction into the page opposite the first direction.

FIG. 43 is a diagrammatic depiction of the flagpole and flag otherwise shown in FIGS. 40 through 42 mounted in the flagpole adapter according to the presently disclosed subject matter showing rotation of the flagpole about a flagpole axis and the fly portion of the flag being wind-directed in a second direction along the X axis opposite the first direction.

### DETAILED DESCRIPTION OF THE EMBODIMENTS

Referring now to the drawings with more specificity, the presently disclosed subject matter concerns a flagpole adapter 10 and flagpole adapter kit incorporating the flagpole adapter 10 for mounting a flagpole 11. The flagpole adapter 10 interchangeably mounts with a flagpole end 13 of a flagpole 11, in a flagpole sleeve mount 21 dimensioned to receive the flagpole end 13, and rotatably supports the flagpole 11 therein. In other words, the flagpole adapter 10, when mounted to a flagpole end 13 of a flagpole 11, is further mountable in a flagpole sleeve mount 21 for rotatably supporting the flagpole 11 therein. The flagpole adapter 10 thereby enables the outfitted flagpole 11 to freely rotate about a flagpole axis 100 extending through the flagpole 11 relative to a main adapter axis 102 at the flagpole sleeve mount 21. The main adapter axis 102 may be fixed when mounted to the flagpole sleeve mount 21 in some embodiments. The flagpole adapter 10 provides a rotatable interface or mount for a flagpole 11 at a mount site.

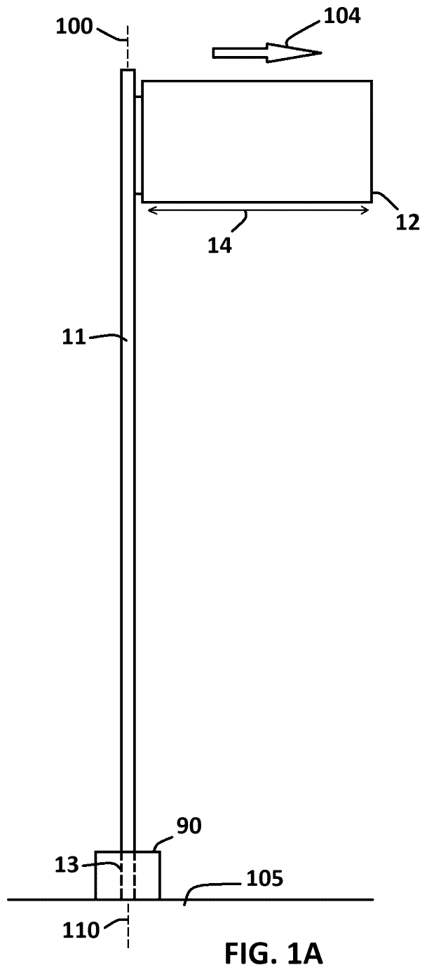

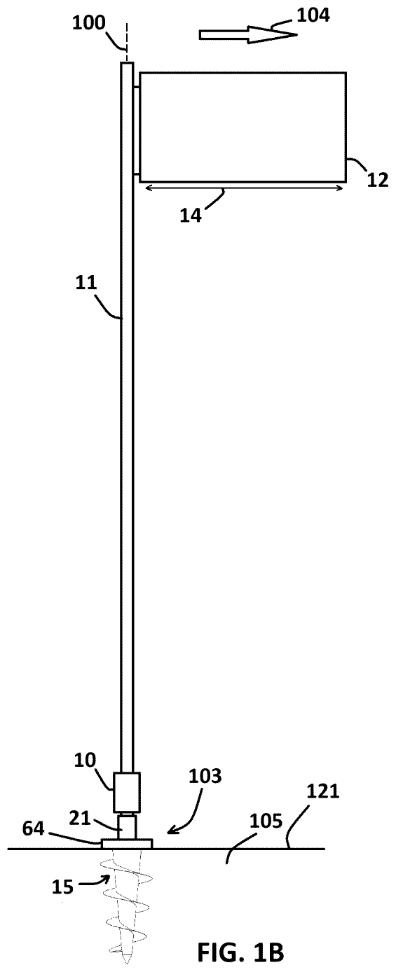

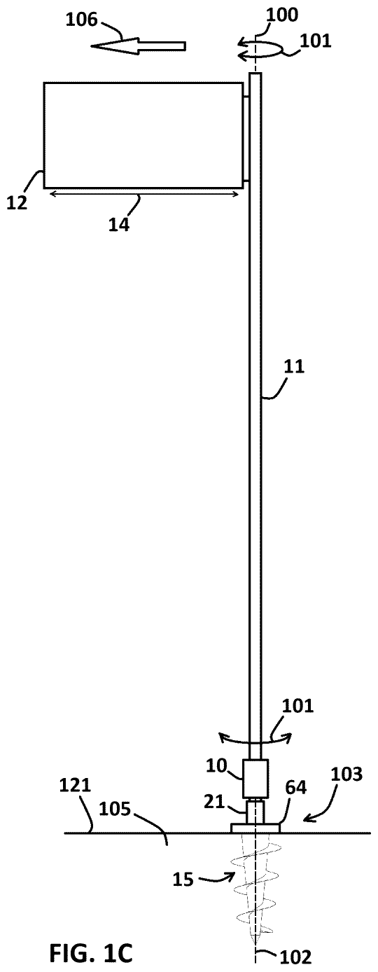

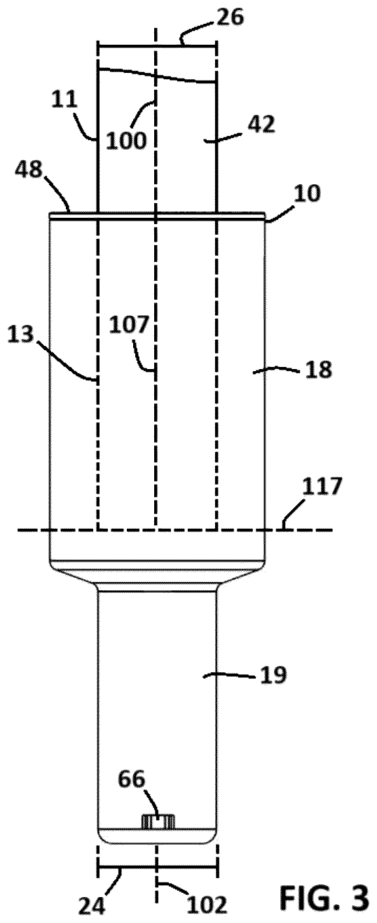

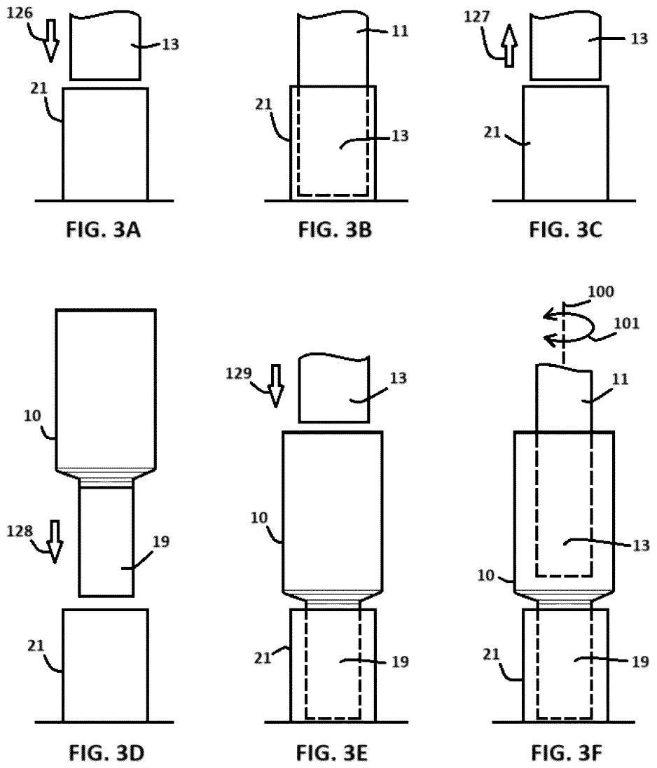

To introduce and illustrate this concept, the reader is firstly directed to FIGS. 1A through 1C and FIGS. 3A through 3F. FIGS. 1A through 1C diagrammatically depict a flagpole 11 with wind-directed flag 12 mounted to the flagpole 11. FIG. 1A depicts the flagpole 11 with a flag 12 mounted thereto such that the fly portion 14 of the flag is wind-directed in a first direction 104. The flagpole 11 illustrated in FIG. 1A is anchored to a ground substrate 105 via a conventional flagpole mount 90. The flagpole end 13 of the flagpole 11 is anchored by the conventional flagpole mount 90 such that rotation of the flagpole 11 about the flagpole axis 100 is made difficult or prevented as at fixed axis 110. It is noted conventional flagpole mounts as generically depicted and referenced at 90 hinder flagpole rotation. The flagpole adapter 10 according to the presently disclosed subject matter enables flagpole 11 rotation about the flagpole axis 100.

Comparatively referencing FIGS. 1B and 1C the reader will there consider the flagpole adapter 10 mounted to the flagpole 11 at the flagpole end 13. As depicted in FIGS. 1B and 1C, the flagpole adapter 10 is anchored to the ground substrate 105 at an anchor site 103 via a first adapter mounting mechanism in the form of a ground anchor 15 having a flagpole sleeve mount 21 at an upper end thereof. The flagpole adapter 10 is mounted to the flagpole 11 at a first, upper end thereof and is mounted to the flagpole sleeve mount 21 at a lower, second end thereof. The flagpole adapter 10 rotatably supports the flagpole 11 at the flagpole sleeve mount 21 of the adapter mounting mechanism exemplified by ground anchor 15 in FIGS. 1B and 1C. The flagpole adapter 10 enables the flagpole 11 to rotate as at arrows 101 about the flagpole axis 100 relative to the main adapter axis 102 of the flag adaptor 10 at the anchor site 103. The main adapter axis 102 may be fixed by mounting an adapter body 16 of the flagpole adapter 10 to the adapter mounting mechanism.

A rotational flagpole 11 may be beneficial during variable wind conditions that redirect the wind-directed fly portion 14 of the flag 12 from the first direction 104 as depicted in FIGS. 1A and 1B to a second direction 106 as depicted in FIG. 1C as, for example, when wind direction reverses. Users may also wish to manually rotate the flagpole 11 about the flagpole axis 100 for changing the orientation of the flag 12 for display purposes. For ease of understanding the second direction 106 as depicted in FIG. 1C is opposite that of the first direction 104 depicted in FIG. 1B. While FIGS. 1B and 1C comparatively depict 180 degrees of rotation of the flagpole 11 about the flagpole axis 100 for ease of understanding, the illustrated example should not be construed as limiting. The rotation enabled by the flagpole adapter 10 may be through 360 degrees in some embodiments.

Comparatively referencing FIGS. 3A through 3F, the reader will there see the flagpole adapter 10 interchangeably mounting with the flagpole end 13 of the flagpole 11 in the flagpole sleeve mount 21, which flagpole sleeve mount 21 is dimensioned to receive the flagpole end 13 and rotatably support the flagpole 11 therein. To demonstrate interchangeable mounting of the flagpole end 13 by the flagpole adapter 10, the reader is firstly directed to FIG. 3A diagrammatically depicting the flagpole end 13 of a flagpole 11 being directed as at arrow 126 into a flagpole sleeve mount 21. The flagpole end 13 is then mounted in the flagpole sleeve mount in FIG. 3B and redirected as at arrow 127 out of the flagpole sleeve mount 21 in FIG. 3C. Once the flagpole end 13 is removed from the flagpole sleeve mount 21, a post-like adapter seat 19 of the flagpole adapter 10 may be directed as at arrow 128 into the flagpole sleeve mount 21. Once the adapter seat 19 of the flagpole adapter 10 is mounted in the flagpole sleeve mount 21 as depicted in FIG. 3E, the flagpole end 13 may be directed as at arrow 129 into the flagpole adapter 10. The flagpole end 13 is then mounted within the flagpole adapter 10 and the flagpole 11 may rotate as at arrows 101 about the flagpole axis 100 as depicted in FIG. 3F.

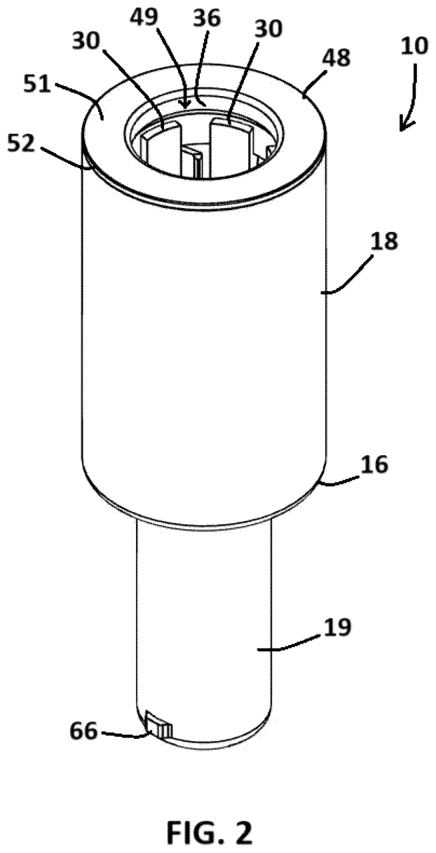

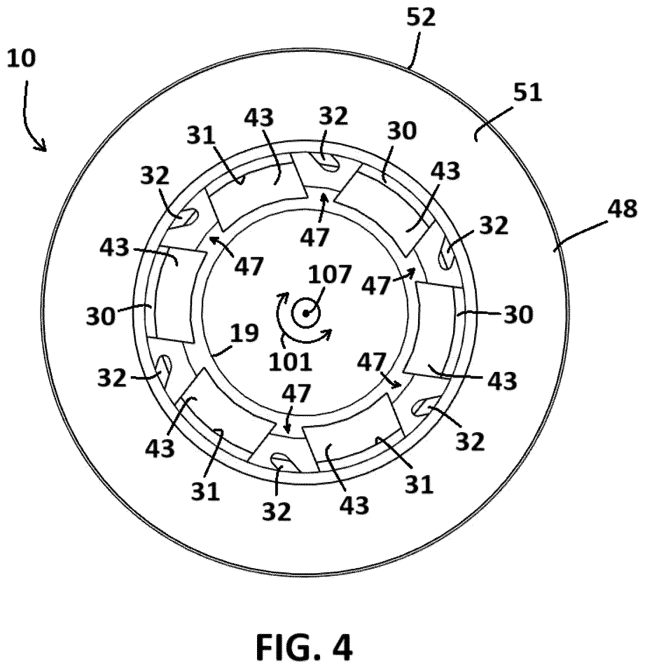

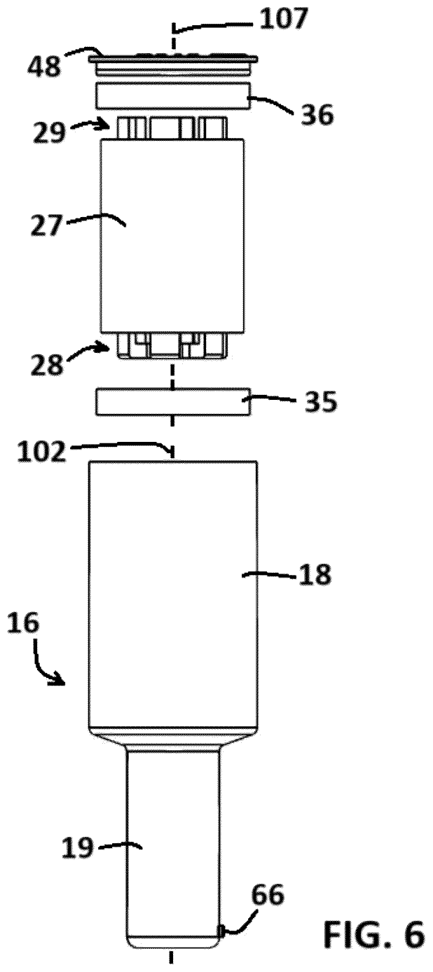

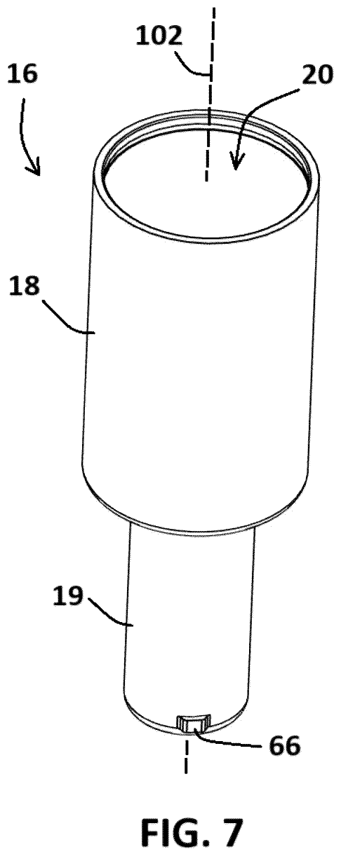

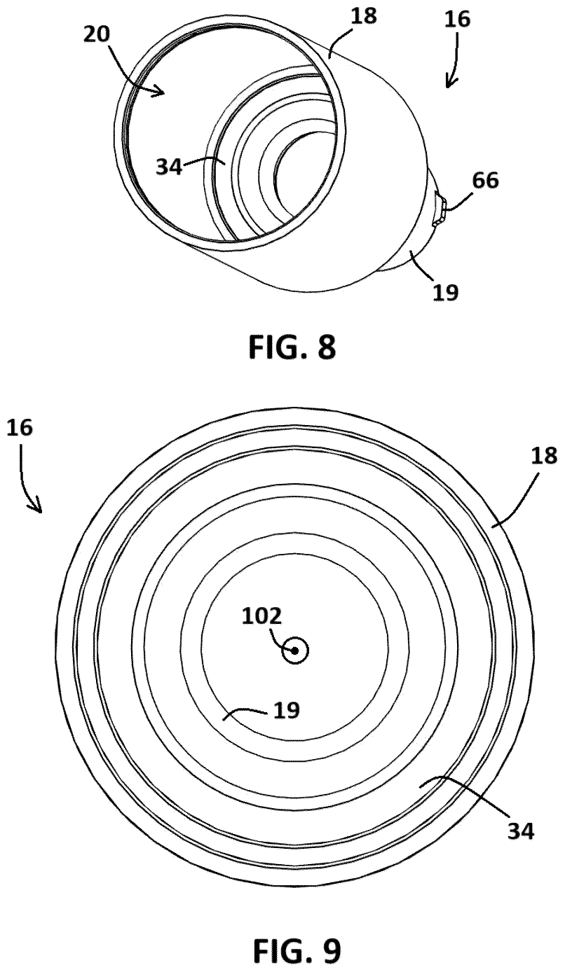

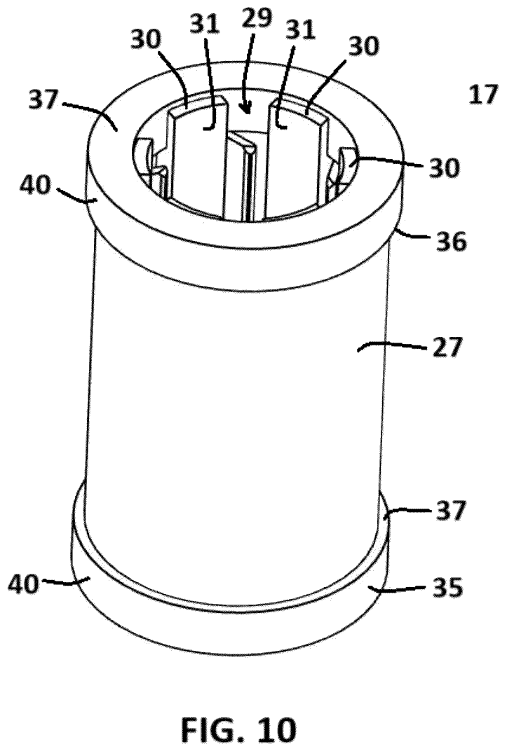

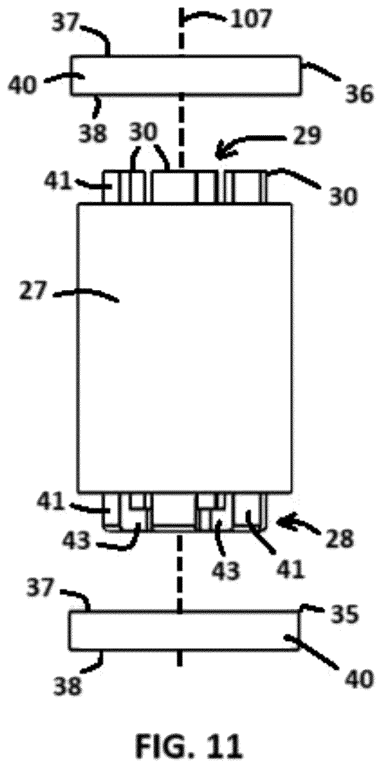

The flagpole adapter 10 according to the presently disclosed subject matter 10 is more particularly depicted and referenced in FIGS. 2, 3, and 4-6 and comprises an anchorable adapter body 16 and a rotation assembly 17 integratable with the adapter body 16 for enabling free rotation of the flagpole end 13 with respect to the adapter seat 19 when the flagpole end 13 is received in the adapter mouth 20. The adapter body is 16 is further depicted and referenced in FIGS. 7-9 and the rotation assembly 17 is further depicted in FIGS. 10 and 11. In some embodiments, the adapter body 16 comprises a barrel portion 18 at an upper end of the adaptor body 16 and the post-like adapter seat 19 extending from the barrel portion 18 at a lower end of the adapter body 16. In some embodiments, the rotation assembly 17 comprises an adapter 27 and a bearing mechanism that enables rotation of the adapter 27 relative to the barrel portion 18 of the adapter body 16. In some embodiments, the rotation assembly may comprise a wheel/roller arrangement whereby the flagpole 11 directly engages with wheels/rollers mounted in the barrel portion 18 (not specifically illustrated).

The barrel portion 18 comprises an upper open adapter mouth 20 and a barrel bottom 34. The rotation assembly 17 is disposed within the adapter mouth 20 as supported by the barrel bottom 34. The rotation assembly 17 is configured to receive and rotatably support the flagpole end 13 as received through the adapter mouth 20 enabling free rotation of the flagpole end 13 of the flagpole 11 within the adapter mouth 20 and with respect to the adapter seat 19 about the main flagpole axis 100. In some embodiments, the adapter body 16 provides a fixed main adapter axis 102 when mounted to the flagpole sleeve mount 21 and the rotation assembly 17 defines an axis of rotation 107. In some embodiments, the main adapter axis 102 and the axis of rotation 107 defined by the rotation assembly 17 are coaxial.

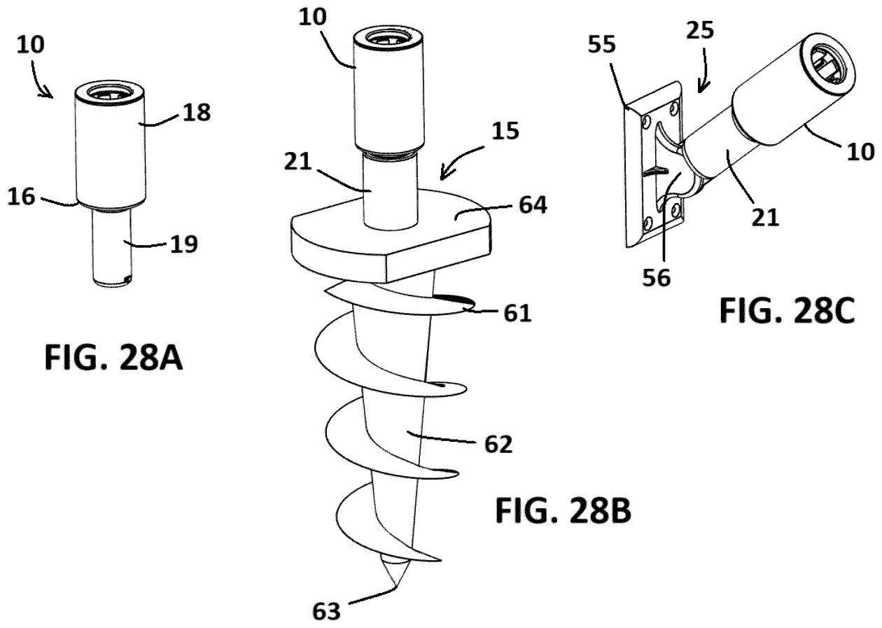

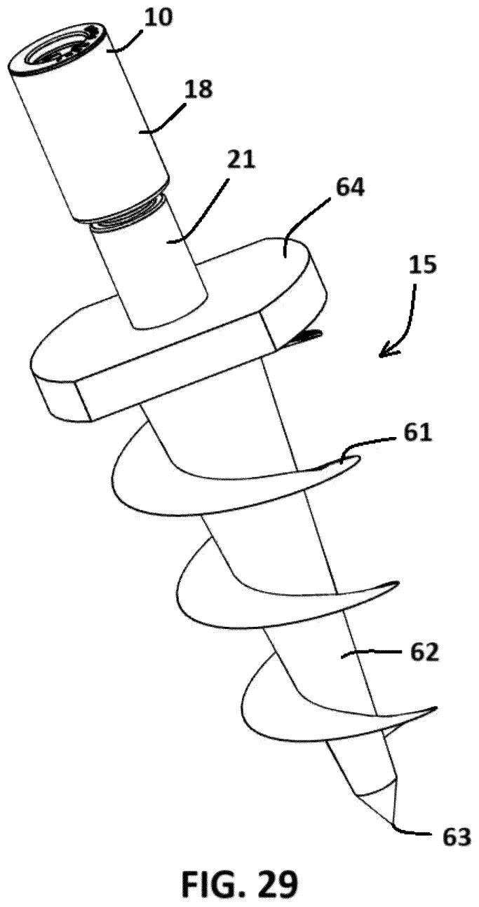

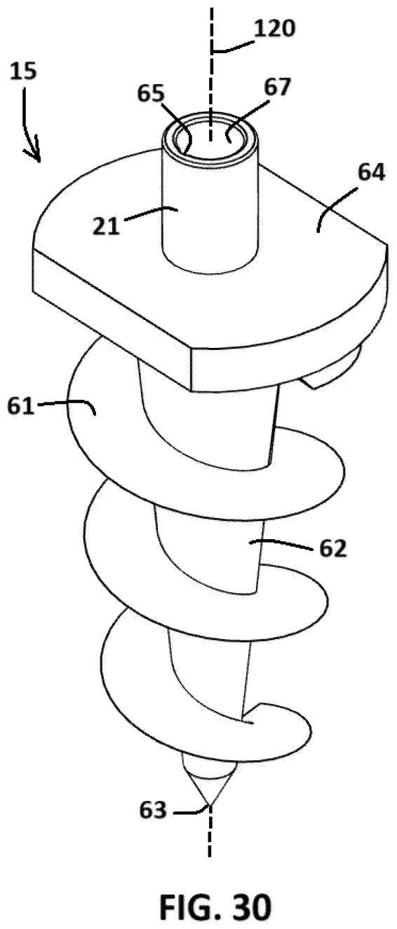

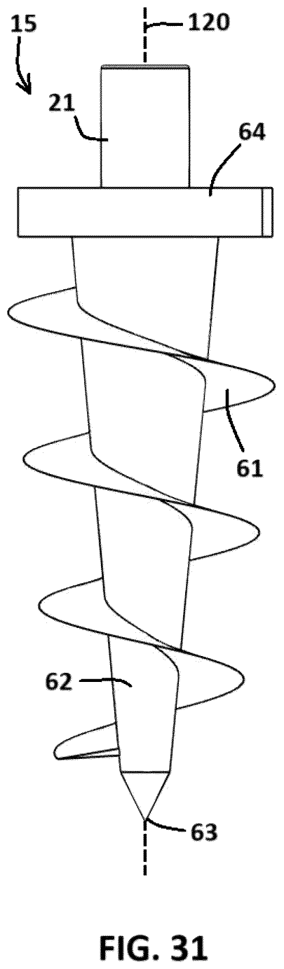

The adapter seat 19 is adapted to be received in a flagpole sleeve mount 21 thereby fixing the main adapter axis 102. In some embodiments, the flagpole sleeve mount 21 is incorporated into an adapter mounting mechanism as variously exemplified according to the presently disclosed subject matter. Referencing FIGS. 28B and 28C, for example, it will there be seen the presently disclosed subject matter contemplates at least two different forms of adapter mounting mechanisms, a first of which is the ground anchor 15 as introduced above and a second of which is a wall anchor 25. Both the ground anchor 15 and the wall anchor 25 adapter mounting mechanisms comprise the flagpole sleeve mount 21 configured to receive and mount a flagpole end 13 of a flagpole 11.

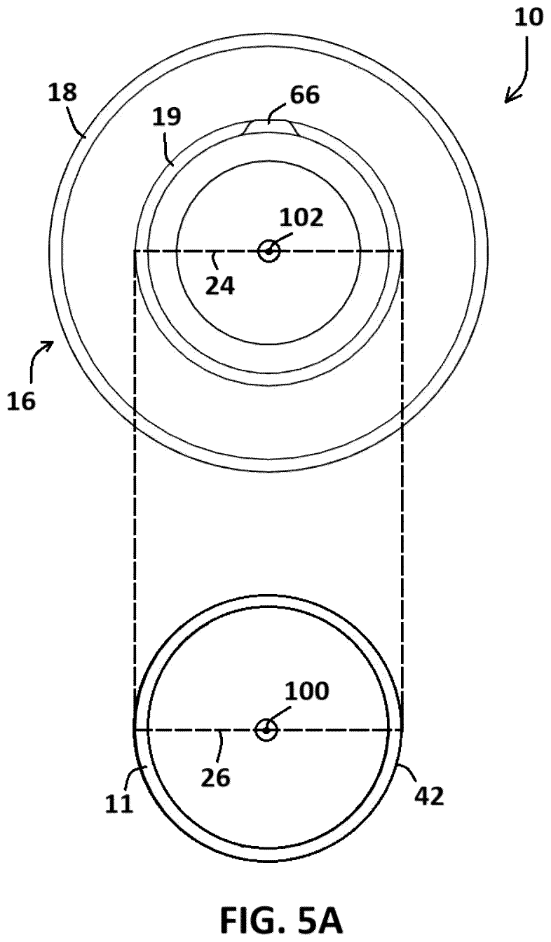

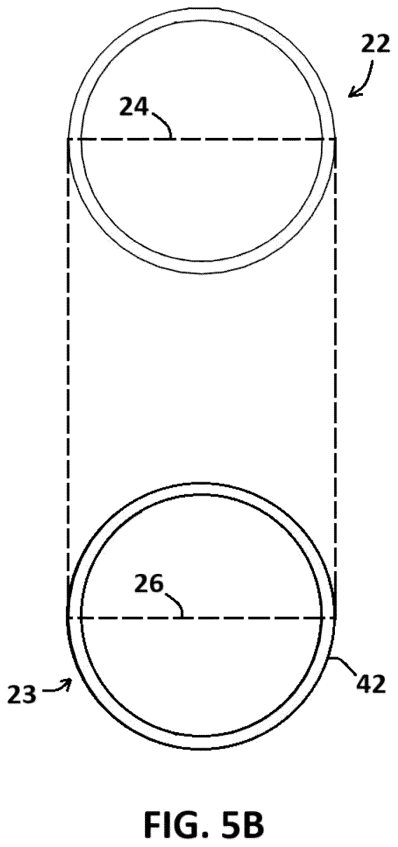

In some embodiments, the adapter seat 19 has a transverse seat cross section as at 22 in FIG. 5B configured for interchangeable mounting with a conventional flagpole 11 in the flagpole sleeve mount 21. In other words, the adapter seat 19 is configured to mimic the flagpole end 13 of a flagpole 11 and as such may be received and supported by the flagpole sleeve mount(s) 21. In some embodiments, the flagpole 11 has a transverse pole cross section 23 equal to the transverse seat cross section 22 as further comparatively depicted in FIG. 5B. In some embodiments, the adapter seat 19 of the flagpole adapter 10 is post-like and cylindrical in form.

In some embodiments, the adapter seat 19 has a seat outer diameter 24 no greater than that of a flagpole outer diameter 26 and in some embodiments the seat outer diameter 24 is equal to the flagpole outer diameter 26 as depicted in FIGS. 3, 5A and 5B. For purposes of the present disclosure, standardized flagpoles typically have outer diameters of between 1 inch (25.4 mm) and 3 inches (76.2 mm), most commonly either 1 inch (25.4 mm) or 2 inches (50.8 mm). The adapter seat 19 of the presently disclosed flagpole adapter 10 can have a seat outer diameter corresponding to these standard flagpole dimensions to enable interchangeable mounting in conventional flagpole sleeve mounts designed for such standardized flagpoles.

In some embodiments, the barrel portion 18 comprises an upper open adapter mouth 20 and a barrel bottom 34. The rotation assembly 17 is disposed within the adapter mouth 20 as supported by the barrel bottom 34. The adapter mouth 20 has an inner diameter sufficient to receive a flagpole end 13, and since the adapter seat 19 is dimensioned to correspond to standardized flagpole dimensions, the inner diameter of the adapter mouth 20 is also sufficient to receive an adapter seat of another like flagpole adapter. Specifically, the outer diameter of any adapter seat 19 is smaller than the inner diameter of any adapter mouth 20, enabling interchangeability between different flagpole adapters 10.

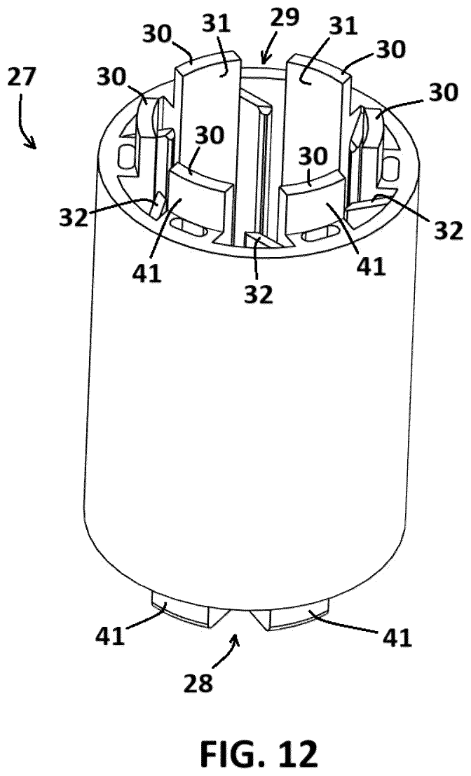

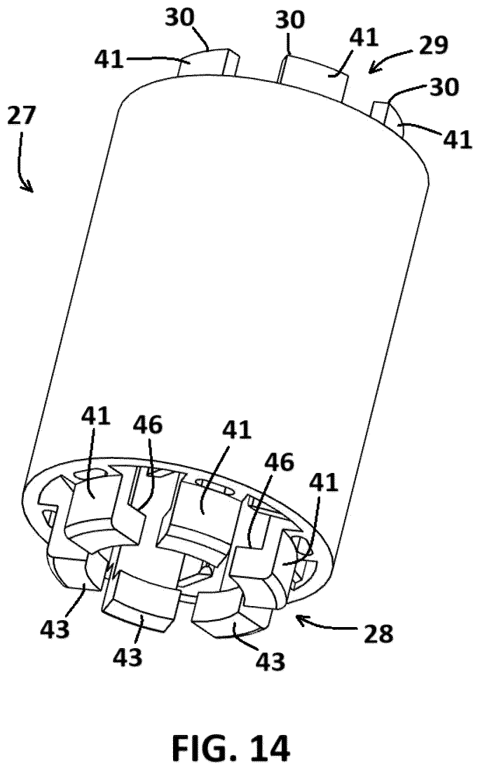

The adapter 27 of the rotation assembly 17 is generally depicted in FIGS. 12-15 and 17 and comprises an adapter seat end 28 and an adapter mouth end 29 in some embodiments. In some embodiments, the barrel portion 18 of the adaptor body is configured to receive the adapter 27 such that adapter seat end 28 is supported adjacent the barrel bottom 34 and adapter seat 19. The adapter mouth end 29 is positioned adjacent the adapter mouth 20. The adapter mouth 20 and the adapter mouth end 29 are configured to receive the flagpole end 13, which flagpole end 13 is then supported by the adapter seat end 28. In some embodiments, the bearing mechanism of the rotation assembly 17 is positioned intermediate the adapter body 16 and the adapter 27 and is configured to enable rotation of the adapter 27 about the axis of rotation 107 within the barrel portion 18 of the adapter body 16.

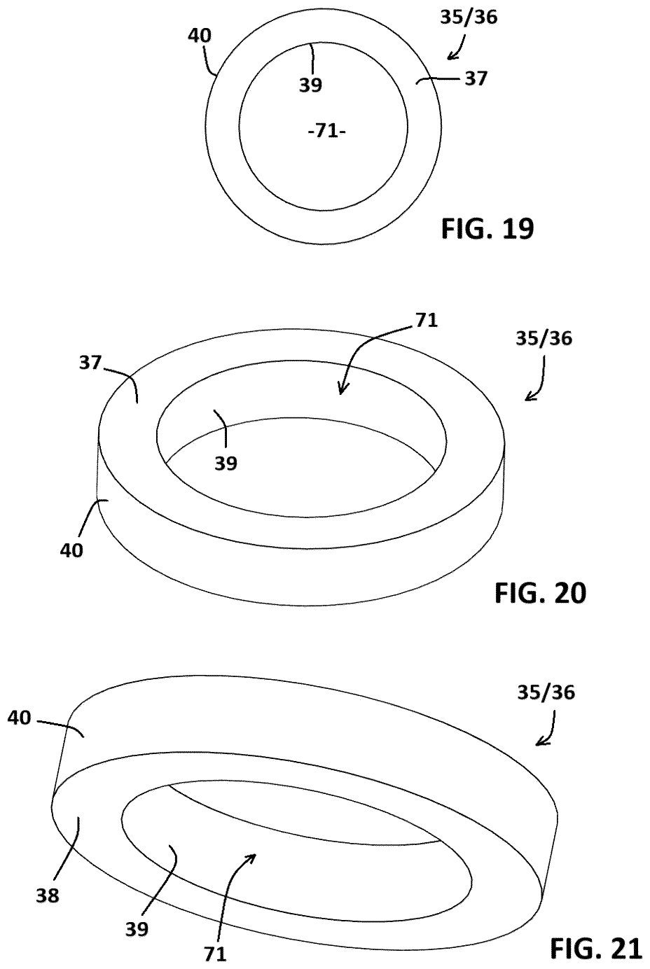

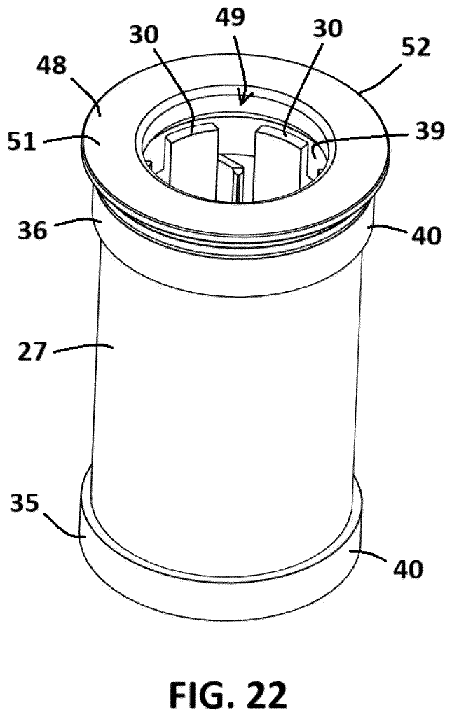

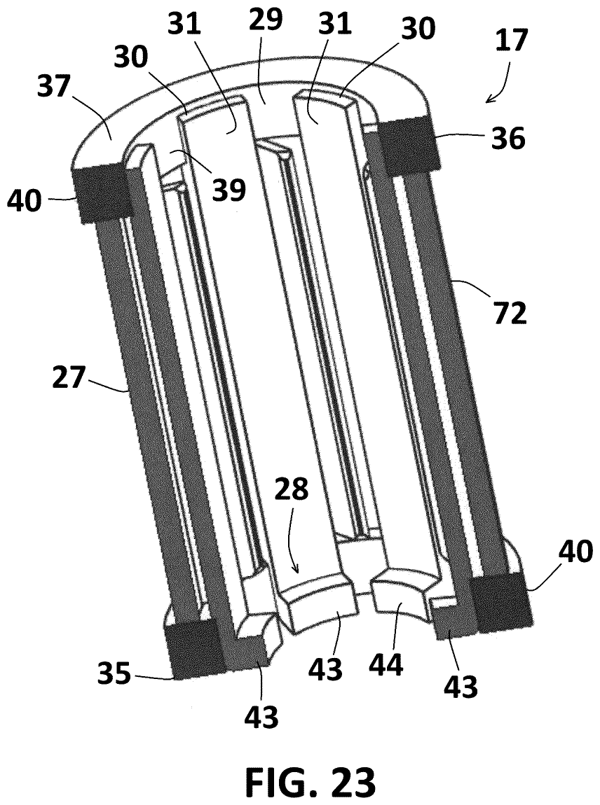

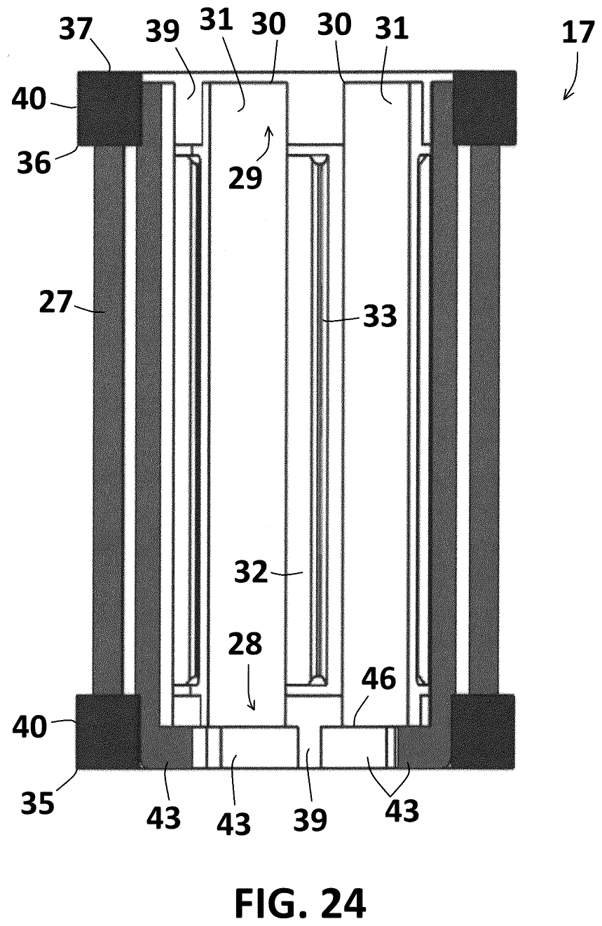

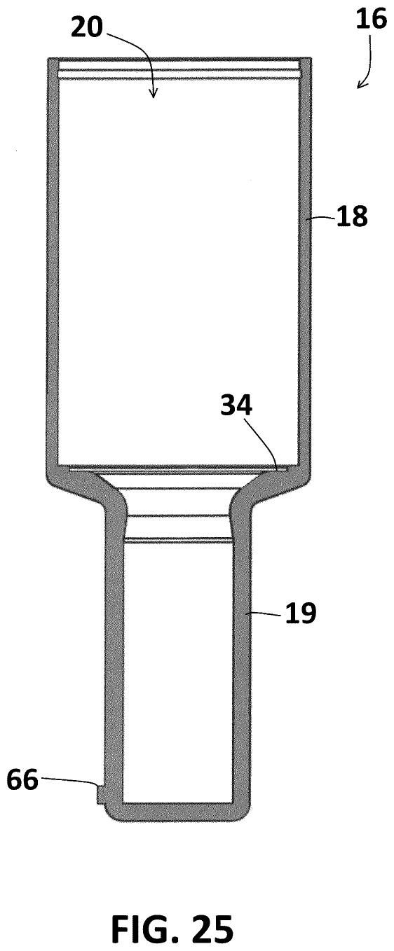

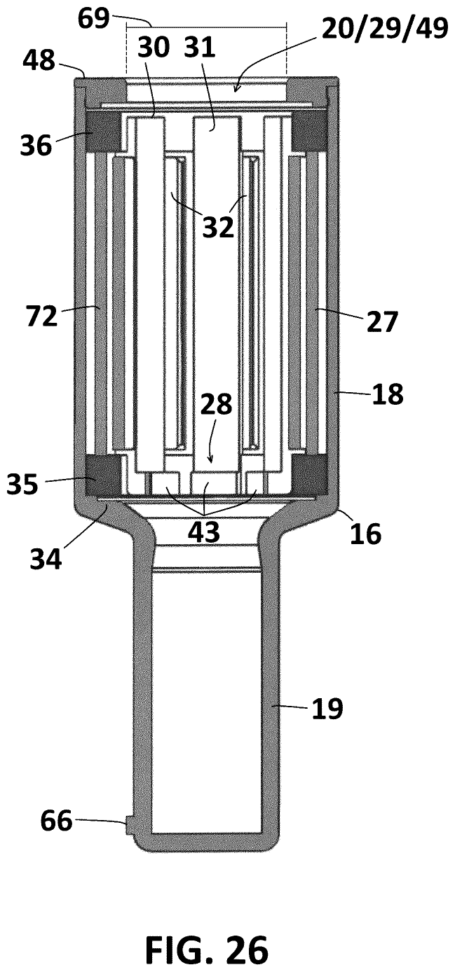

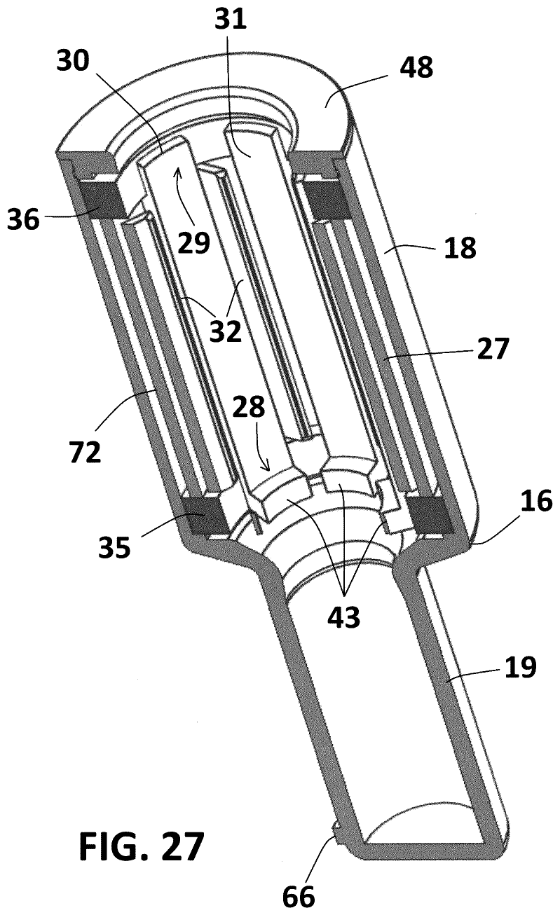

In some embodiments, the bearing mechanism of the rotation assembly 17 may comprise an annular seat bearing 35 and an annular mouth bearing 36. The seat bearing 35 is positioned at the adapter seat end 28 and barrel bottom 34 and the mouth bearing 36 is positioned intermediate the adapter mouth 20 and the adapter mouth end 29 enabling rotation of the adapter 27 relative to the barrel portion 18 of the adapter body 16. In some embodiments, the seat bearing 35 is substantially identical to the mouth bearing 36 and as such is singularly depicted in FIGS. 19-21. In some embodiments, the seat bearing 35 and the mouth bearing 36 each comprise an upper bearing surface 37, a lower bearing surface 38, a radially inner bearing surface 39 and a radially outer bearing surface 40. In some embodiments, a transverse cross section through these surfaces is rectangular in form as generally depicted in FIGS. 23, 24, 26 and 27. In some embodiments, the transverse cross section is square.

In some embodiments, the adapter 27 comprises a plurality of circumferentially spaced support portions 30 extending in radial outer adjacency to a main collar axis extending coaxially with the axis of rotation 107. The support portions 30 are configured to radially engage and support the flagpole end 13. In some embodiments, the support portions 30 extend from the adapter mouth end 29 to the adapter seat end 28. In some embodiments, the support portions 30 are integrally or monolithically formed with the adapter seat end 28. The support portions 30 each comprise an inner support surface 31. The inner support surfaces 31 of the support portions 30 are configured to support an outer pole surface 42 of the flagpole end 13.

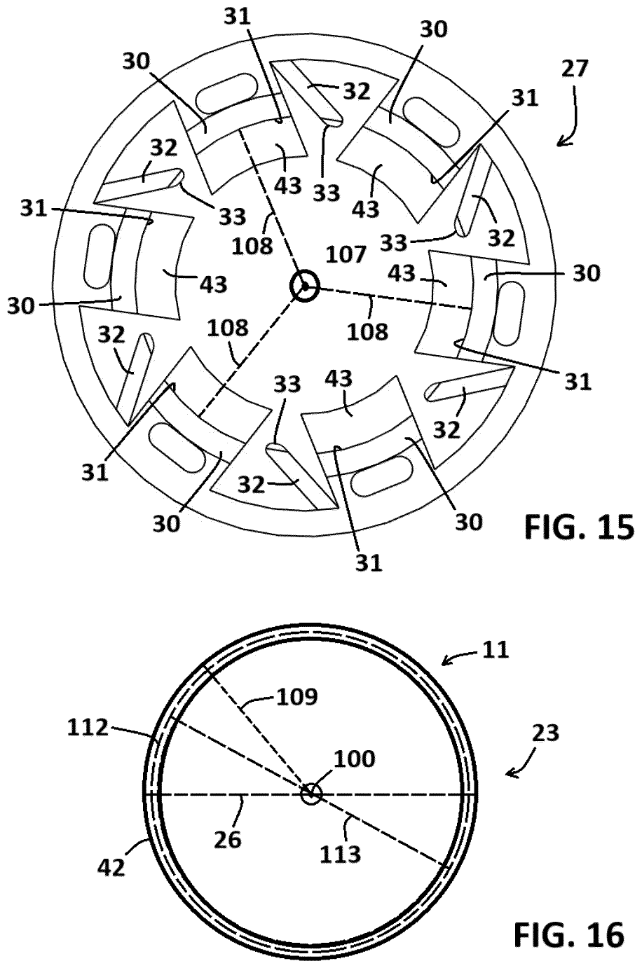

In some embodiments, the outer pole surface 42 of the flagpole end 13 is circular and the inner support surfaces 31 of the support portions 39 are radiused to correspondingly mate with or engage the outer pole surface 42. In some embodiments, the inner support surfaces 31 each comprise a uniform radius as at 108 in FIG. 15. In some embodiments, the uniform radii 108 of the inner support surfaces 31 equal a flagpole end radius 109 equal to half the flagpole outer diameter 26 extending transversely relative to the flagpole axis 100 as referenced in FIG. 16.

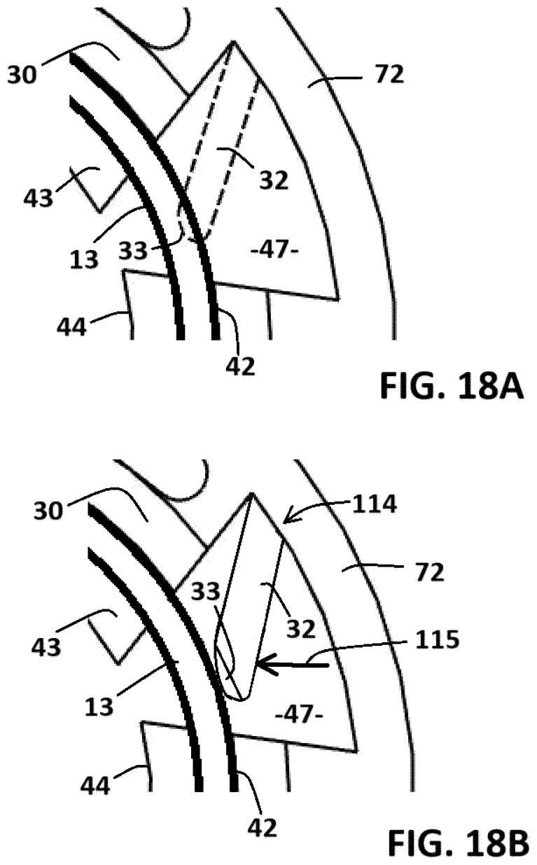

In some embodiments, the adapter 27 comprises at least one pole-locking mechanism 32. In some embodiments, the adapter 27 comprises a plurality of circumferentially spaced pole-locking mechanisms 32. In some embodiments, the pole-locking mechanisms 32 are alternatingly positioned intermediate the circumferentially spaced support portions 30. In some embodiments, the pole-locking mechanisms 32 are resiliently actuable to resiliently engage the flagpole end 13 for gripping or locking the flagpole end 13 within the adapter 27 as comparatively depicted in FIGS. 18A and 18B.

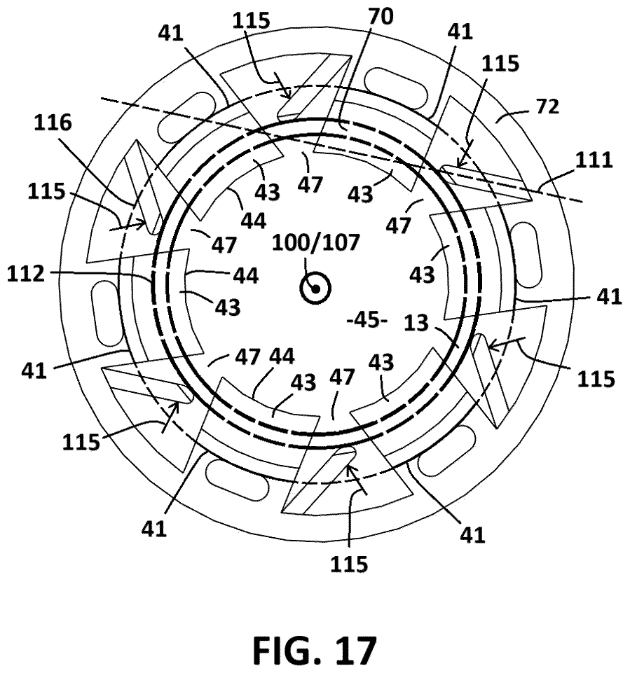

FIG. 18A depicts an exemplary pole-locking mechanism 32 in broken lining to depict a relaxed configuration and FIG. 18B depicts the exemplary pole-locking mechanism 32 in an actuated configuration such that the exemplary pole-locking mechanism 32 resiliently returns as at arrow 115 to engage the outer pole surface 42 of the flagpole end 13. In some embodiments, the pole-locking mechanisms 32 extend inwardly from the adapter 27 obliquely relative to an outer collar wall 72 along a chord plane 111 extending in parallel relation to the axis of rotation 107 such that the chord plane(s) 111 each extend through an arcuate pole portion 70 of the flagpole end 13 as comparatively depicted and referenced in FIGS. 17-18B.

In some embodiments, each pole-locking mechanism 32 comprises an inner lock edge 33, which inner lock edges 33 together define a locking circumference as at 112. FIG. 16 depicts the locking circumference 112 in a relaxed configuration overlayed with the transverse pole cross section 23 of the flagpole 11. The relaxed configuration of the locking circumference 112 has a relaxed diameter 113 less than the pole diameter 26 in some embodiments. The locking circumference 112 is configurable intermediate a relaxed configuration as depicted in FIG. 16 and an actuated configuration as depicted in FIG. 17. When the flagpole end 13 of the flagpole 11 is received by the adapter 27, it seats upon the adapter seat end 28 and the pole-locking mechanisms 32 are resiliently actuated into the actuated configuration 114 as generally depicted and referenced in FIG. 18B. The diameter of the locking circumference 112 of the inner lock edges 33 when in the actuated configuration 114 is equal to the flagpole outer diameter 26 as generally depicted in FIG. 17. In some embodiments, the inner lock edges 33 may be formed from or comprise a resilient, gripping material such as rubber or similar other material that may operate to grip the outer pole surface 42 of the flagpole end 13.

In some embodiments, the support portions 30 each further comprise an outer support surface 41 at the adapter mouth end 29 and the adapter seat end 28. The outer support surfaces 41 together define an outer support surface circumference 116 rotatably matable with the inner bearing surfaces 39 of the seat bearing 35 and the mouth bearing 36. The outer support surface circumference 116 is further referenced in FIG. 17. In other words, the diameter of the circular shape defined by the outer support surface circumference 116 is substantially equal to the diameter of the through hole 71 defined by the inner bearing surfaces 39 with a tolerance to respectively allow rotation of the adapter seat end 28 and the adapter mouth end 29 relative to the seat bearing 35 and the mouth bearing 36. The seat bearing 35 and the mouth bearing 36 are thus rotatably matable with the outer support surfaces 41 at the adapter seat end 28 and the adapter mouth end 29 in some embodiments.

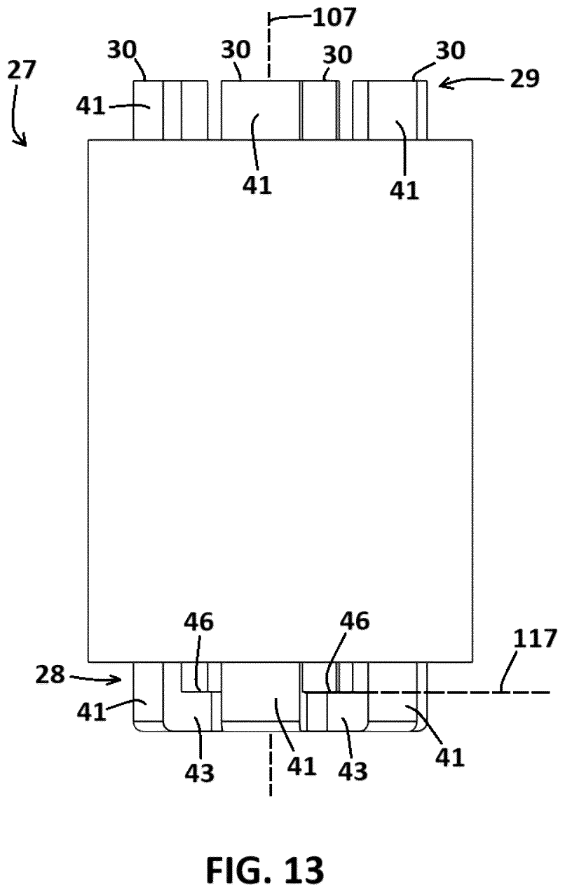

In some embodiments, the adapter seat end 28 of the adapter 27 comprises a plurality of circumferentially spaced seat supports 43 extending radially inwardly from the inner support surfaces 31 at seat ends of the support portions 30. The flagpole end 13 rests upon the seat supports 43 when inserted into the adapter 27. In some embodiments, each seat support 43 comprises a radiused inner seat surface 44. Together the radiused inner seat surfaces 44 define a seat aperture 45 the diameter of which is less than the flagpole outer diameter 26 as depicted in FIG. 17. In some embodiments, each seat support 43 comprises a planar upper seat surface 46, which upper seat surfaces 46 are coplanar within a seat support plane 117 as referenced in FIGS. 3 and 13.

In some embodiments, the circumferentially spaced seat supports 43 define adapter gaps 47 therebetween as further referenced in FIG. 17. In some embodiments, the seat supports 43 are configured to both support the flagpole end 13 and cooperate with the adapter gaps 47 to enable seat resilience such that the support portions 30 snugly receive and support the flagpole end 13. In other words, in some embodiments, the circumferentially spaced seat supports 43 and adapter gaps 47 enable resilient action at the adapter seat end 28 to help the support portions 30 resiliently engage the flagpole end 13 for snugly supporting the same within the adapter 27.

In some embodiments, the flagpole adapter 10 may further comprise an annular adapter cap 48 attachable to the adapter mouth 20 for enclosing the adapter 27 within the barrel portion 18 of the adapter body 16. The flagpole end 13 is insertable into the adapter mouth 20 and adapter mouth end 29 via a cap aperture 49 of the annular adapter cap 48. In some embodiments, the annular adapter cap 48 comprises a lower cap surface 50 and an upper cap surface 51. In some embodiments, the lower cap surface 50 of the adapter cap 48 extends in cap plane in spaced relation to the upper bearing surface 37 of the mouth bearing 36. In some embodiments, the lower cap surface 50 may seat upon the upper bearing surface 37. The upper cap surface 51 has a sufficient width between the cap aperture 49 and an outer cap edge 52 so as to be outfitted with indicia in some embodiments to denote branding or other useful information.

The flag adapter kit according to the presently disclosed subject matter includes the flag adaptor 10 and one or more adapter mounting mechanisms that mount to the flag adapter 10 at the adapter seat 19. While the presently disclosed subject matter presents two exemplary adapter mounting mechanisms in the form of a ground anchor 15 and a wall anchor 25, this should not be construed as limiting. The adapter seat 19 of the flag adapter 10 is configured to be mated with a flagpole sleeve mount 21 which can be incorporated into any number of adapter mounting mechanisms. It will be recalled the adapter seat 19 is configured to mimic a flagpole end 13 and as such, the flagpole adapter 10 can be used as a flagpole end adapter for virtually any conventional flagpole 11 mountable in conventional flagpole mounts as generically depicted and referenced at 90. The flagpole adapter 10, may for example, be mounted in the conventional flagpole mount 90 since the adapter seat 19 mimics the flagpole end 13.

The flagpole adapter kit according to the presently disclosed subject matter mounts a flagpole 11 and enables the flagpole 11 as mounted to freely rotate about a flagpole axis 100. The flagpole adapter kit according to the presently disclosed subject matter comprises a flagpole adapter 10 and an adapter mounting mechanism. The flagpole adapter 10 comprises the adapter body 16 and the rotation assembly 17 configured to rotate relative to the adapter body 17. The adapter body 16 has a fixable main adapter axis 102. The rotation assembly 17 defines an axis of rotation 107 and is configured to receive and affix to a flagpole end 13 of the flagpole 11. The adapter mounting mechanism is configured to anchor the adapter body 16 thereby fixing the main adapter axis 102. At least a portion of the rotation assembly 17 is rotatable about the axis of rotation 107 relative to the adapter body 16 for rotating the flagpole 11 about the flagpole axis 100.

In some embodiments, the adapter body 16 comprises an adapter seat 19 extending along the main adapter axis 102, which adapter seat 19 has a transverse seat cross section 22 configured for interchangeable mounting with a conventional flagpole 11 in a flagpole sleeve mount 21 of the adapter mounting mechanism. In some embodiments, the adapter seat 19 comprises a seat outer diameter 24, which seat outer diameter 24 is no greater than the flagpole outer diameter 26 of the flagpole 11 and lesser or smaller than a mouth inner diameter 69. In some embodiments, the flagpole 11 has a transverse pole cross section 23 equal to the transverse seat cross section 22 as comparatively depicted in FIG. 5B. In some embodiments, the post-like adapter seat 19 is cylindrical in form and matable with a female mount portion 54 of the flagpole sleeve mount 21 of the adapter mounting mechanisms.

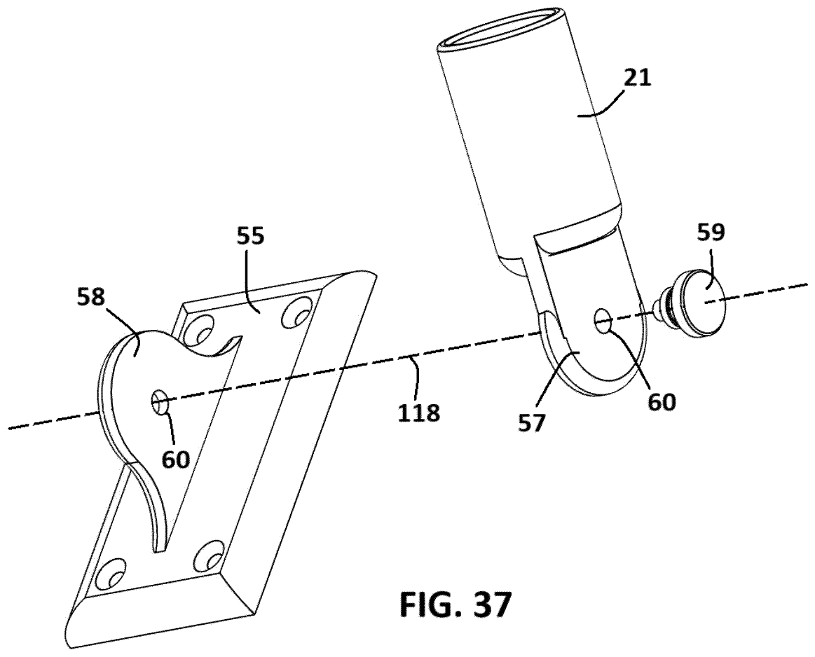

In some applications, the adapter mounting mechanism of the flagpole adapter kit may be characterized by a ground anchor as at 15 and in other applications the adapter mounting mechanism may be characterized by a wall mount as at 25. In some applications, the flagpole adapter kit may include both of these mounts as well as other types of adapter mounting mechanisms not particularly here specified. Both the ground anchor 15 and the wall anchor 25 comprise a flagpole sleeve mount as at 21 which mates with the adapter seat 19. In some embodiments, the flagpole sleeve mount 21 comprises a female mount portion 54 having an inner sleeve diameter as at 53 in FIG. 37. The inner sleeve diameter 53 is dimensioned to matably correspond with the seat outer diameter 24, which, in some embodiments, is no greater than or equal to the flagpole outer diameter 26.

In some embodiments, the ground anchor 15 may comprise a spiral-shaped blade 61 extending from a central shaft portion 62 opposite the flagpole sleeve mount 21 and separated therefrom by a divider plate portion 64. In some embodiments, the central shaft portion 62 is conical in form terminating in a ground-piercing point 63. The ground-piercing point 63 and the spiral-shaped blade 61 extending from a central shaft portion 62 enable a user to screw the ground anchor 15 into a ground substrate 105 thereby anchoring the flagpole sleeve mount 21 at an anchor site as at 103 such that the divider plate portion 64 is positioned at a ground surface 121 as depicted in FIGS. 1B and 1C. The flagpole adapter 10 may then be mounted to the flagpole sleeve mount 21 for fixing the main adapter axis 102 of the adapter body 16. The flagpole adapter 10 may then receive a flagpole end 13 of a flagpole 11 and the rotation assembly 17 of the flag adapter 10 enables rotation of the flagpole 11 about its flagpole axis 100 coaxially aligned with the axis of rotation 107.

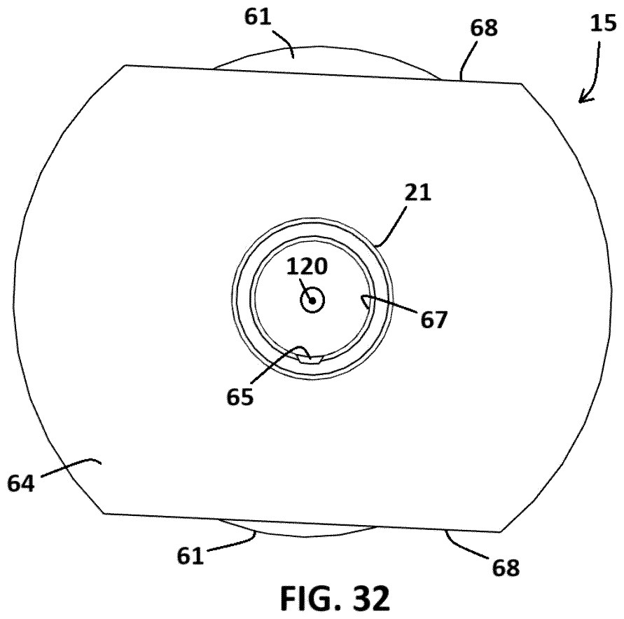

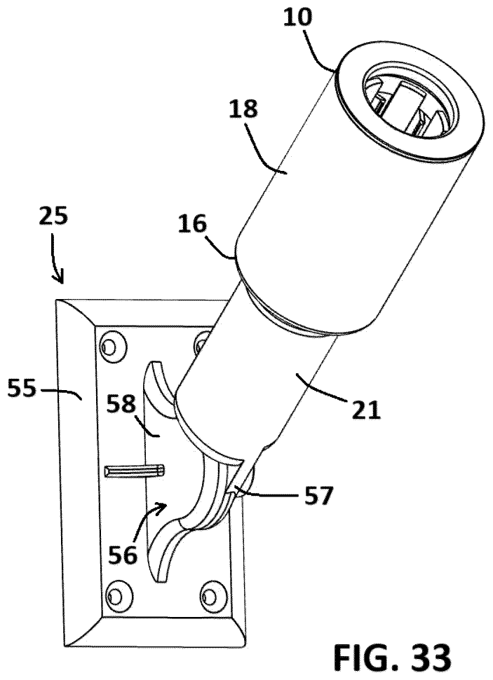

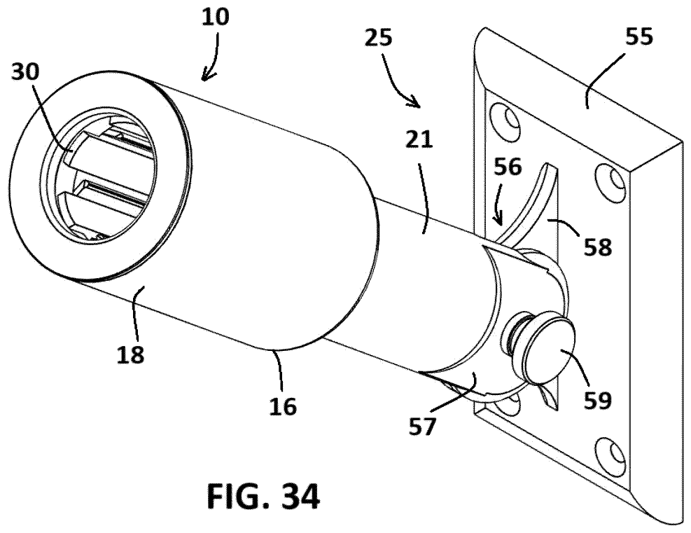

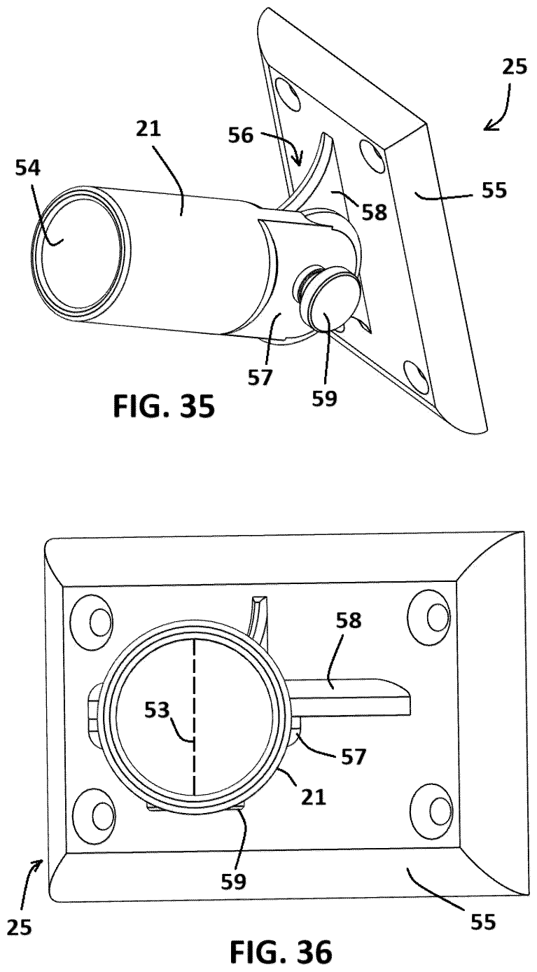

In some embodiments, the flagpole sleeve mount 21 of the ground anchor 15 may comprise a first locator formation 65 at an inner sleeve surface 67 as depicted and referenced in FIG. 32. In this regard, the adapter seat 19 may further comprise a second locator formation 66 matable with the first locator formation 65. The first and second locator formations 65 and 66 fix the main adapter axis 102 relative to a screw axis 120 of the ground anchor 15. In some embodiments, the first locator formation 65 is a notch or cavity formed at the inner sleeve surface 67 and the second locator formation 66 is a protuberance extending outwardly from the anchor seat 19 at an end thereof. The protuberance or second locator formation 66 is matably received in the notch or first locator formation 65 thereby preventing rotation of the adapter body 16 about the main adapter axis 102 relative to the screw axis 120 extending through the ground anchor 15.

In some embodiments, the divider plate portion may comprise plate edges 68 as referenced in FIG. 32. The plate edges 68 in some embodiments may be configured to engage a tool for turning the divider plate portion 64 about the screw axis 120. The ground anchor 15, when being screwed into a ground substrate 105, may require significant torque to properly direct the ground anchor 15 into the ground substrate for anchoring the flagpole sleeve mount 21. In this regard, the tool for applying the torque has a lever arm and a plate interface portion for interfacing with the plate edges 68. In some embodiments, the plate edges 68 are opposed to one another and in some embodiments are parallel to one another for engaging a tool interface having opposed plate-engaging jaws.

The wall anchor 25 may include a mount plate 55 for anchoring the wall anchor 25 to a wall and a bracket assembly 56 extending intermediate the wall plate 55 and the flagpole sleeve mount 21. In some embodiments, the bracket assembly is configured to obliquely angle the flagpole sleeve mount 21 relative to the wall plate 55. In some embodiments, the bracket assembly 56 may provide a mechanism for adjusting the angular relationship of the flagpole sleeve mount 21 relative to the wall plate 55. In some embodiments, this mechanism may include a mount extension 57 extending from an attachment end of the flagpole sleeve mount 21, a plate extension 58 extending from the wall plate 55, and a screw type adjustment knob 59.

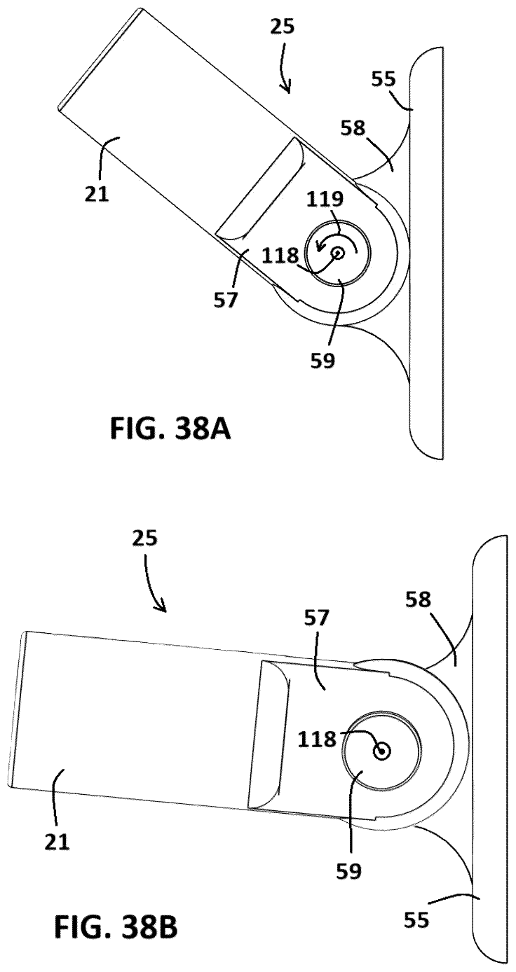

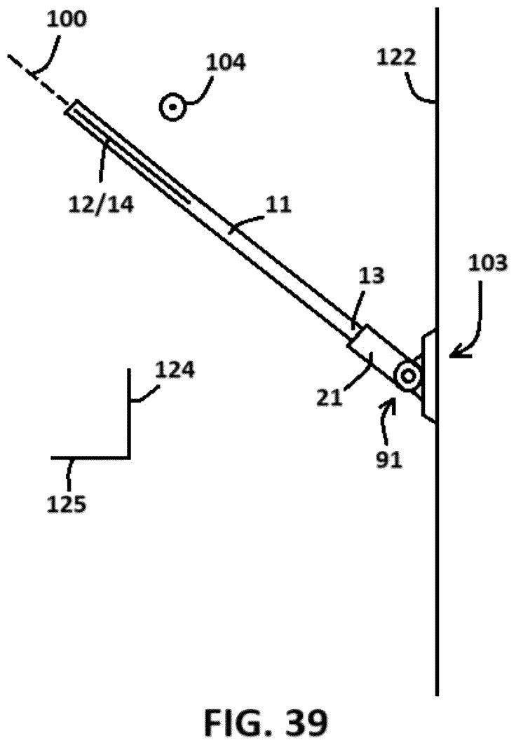

The mount extension 57 and plate extension 58 may each comprise apertures 60 and may be adjustably fastened to one another via the adjustment knob 59 receivable in the apertures 60. The adjustment knob 59 may be loosened and tightened to enable the flagpole sleeve mount 21 to pivot as at arrow 119 about a pivot axis 118 extending through the knob 59 and apertures 60 for varying the angular relationship of the flagpole sleeve mount 21 relative to the wall plate 55 in some embodiments. Comparatively referencing FIG. 38A versus FIG. 39B, the reader will there consider the flagpole sleeve mount 21 in two angled configurations.

A first angled configuration of the flagpole sleeve mount 21 relative to the wall plate 55 is depicted in FIG. 38A and a second angled configuration of the flagpole sleeve mount 21 relative to the wall plate 55 is depicted in FIG. 39B. The adjustment knob 59 may be manually turned to enable the flagpole sleeve mount 21 to be pivoted as at 119 about the pivot axis of rotation 118 and returned to prevent further rotation about the pivot axis of rotation 118 for fixing the second angled configuration of the flagpole sleeve mount 21 relative to the wall plate 55.

Referencing FIGS. 39-43, the reader will there consider diagrammatic depictions of a flagpole 11 mounted to a wall 122 via a wall anchor. The reader is first directed to FIG. 39 depicting a conventional wall anchor 91 attached to the wall 122 and mounting a flagpole 11. FIG. 39 depicts the flagpole 11 with flag 12 mounted thereto such that the fly portion 14 of the flag is wind-directed in the first direction 104 out of the page. The flagpole end 13 of the flagpole 11 is anchored by the conventional wall anchor 91 such that rotation of the flagpole 11 about the flagpole axis 100 is made difficult or prevented as with the conventional flagpole mount 90.

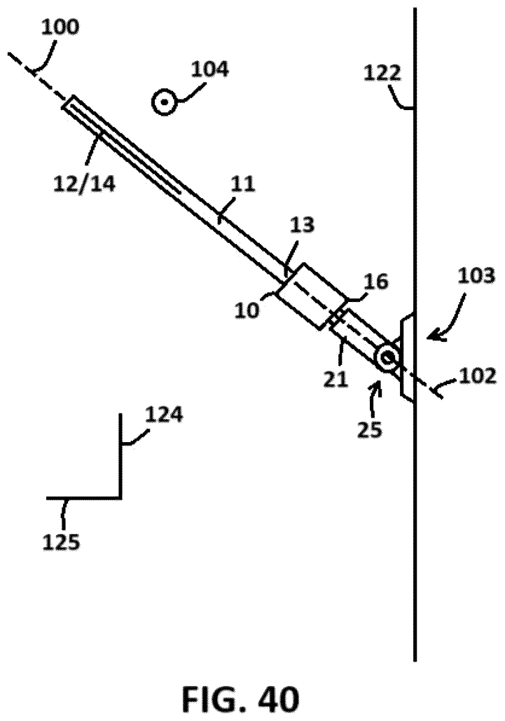

Comparatively referencing FIGS. 40-43, the reader will there consider the flagpole adapter 10 mounted to the flagpole 11 at the flagpole end 13. As depicted in FIGS. 40-43, the flagpole adapter 10 is anchored to the wall anchor 25 having a flagpole sleeve mount 21 at an upper end thereof. The flagpole adapter 10 rotatably supports the flagpole 11 at the flagpole sleeve mount 21 of the adapter mounting mechanism exemplified by wall anchor 25 in FIGS. 40-43. The flagpole adapter 10 enables the flagpole 11 to rotate as at arrows 101 about the flagpole axis 100 relative to the main adapter axis 102 of the flag adaptor 10 at the anchor site 103. The main adapter axis 102 may be fixed by mounting the adapter body 16 of the flagpole adapter 10 to the wall anchor 25 adapter mounting mechanism.

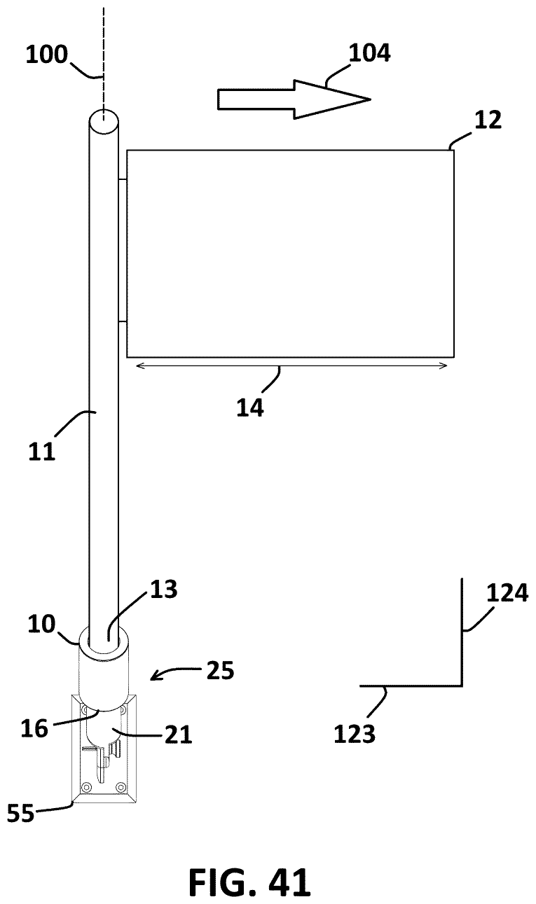

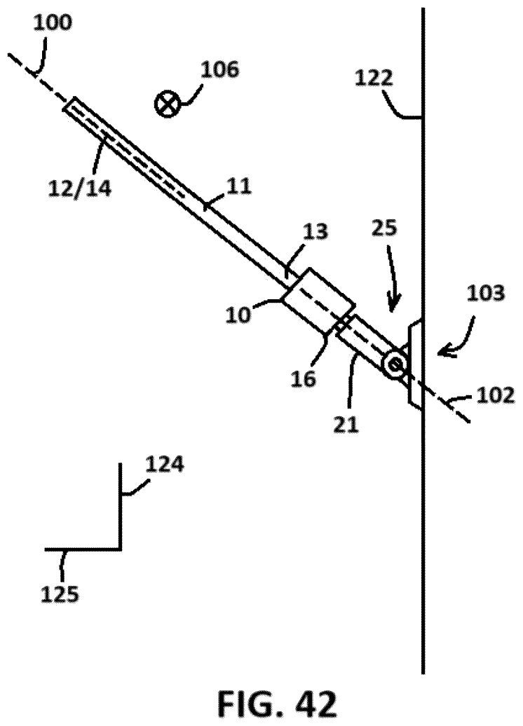

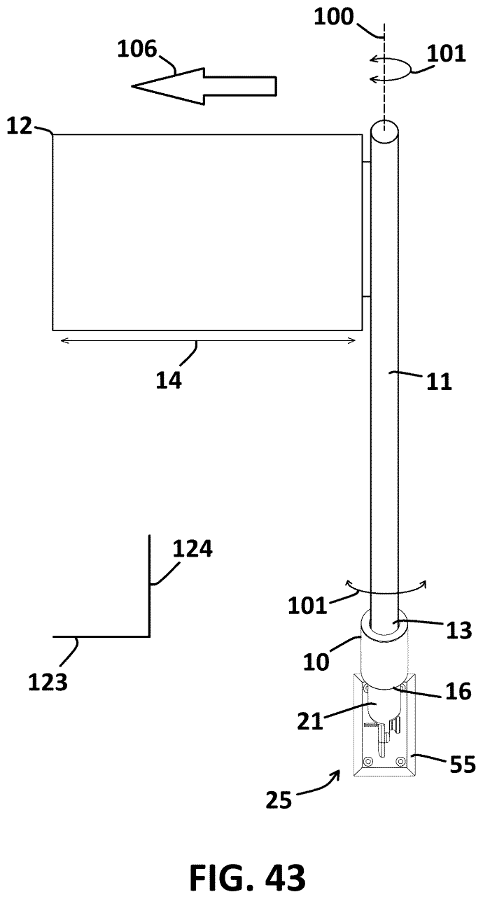

It will be recalled a rotational flagpole 11 may be beneficial during variable wind conditions that redirect the wind-directed fly portion 14 of the flag 12 from the first direction 104 as depicted in FIGS. 39-41 to a second direction 106 as depicted in FIGS. 42 and 43 when wind direction reverses, for example. FIGS. 39 and 40 depict the flag 12 in solid lining such that the fly portion 14 extends out of the page orthogonal to the Y axis 124 and Z axis 125. FIG. 41 depicts the fly portion 14 being wind-directed in the first direction 104 to the right of the page along the X axis 123. FIG. 42 depicts the flag 12 in broken, hidden lining such that the fly portion 14 extends into the page orthogonal to the Y axis 124 and Z axis 125. FIG. 43 depicts the fly portion 14 being wind-directed in the second direction 106 to the left of the page opposite the first direction 104 along the X axis 123. While FIGS. 41 and 43 comparatively depict 180 degrees of rotation of the flagpole 11 about the flagpole axis 100 via the flagpole adapter 10 for ease of understanding, the illustrated wall anchor 25 examples should not be construed as limiting. The rotation enabled by the flagpole adapter 10 is through 360 degrees in some embodiments.

What is claimed is:

1. A flagpole adapter for interchangeable mounting with a flagpole end of a flagpole, in a flagpole sleeve mount dimensioned to receive said flagpole end, and rotatably supporting said flagpole therein, the flagpole adapter comprising:
an adapter body comprising:
an adapter mouth dimensioned for receiving said flagpole end; and
an adapter seat dimensioned to be received in said flagpole sleeve mount; and
a rotation assembly integratable with the adapter body for enabling free rotation of said flagpole end with respect to the adapter seat, when the flagpole end is received in the adapter mouth, wherein the rotation assembly comprises at least one pole-locking mechanism that is resiliently actuable to resiliently engage the flagpole end,
wherein the at least one pole-locking mechanism comprises an inner lock edge defining a locking circumference that is configurable between: a relaxed configuration having a relaxed diameter less than a flagpole diameter of the flagpole end, and an actuated configuration when engaging the flagpole end.

2. The flagpole adapter according to claim 1, wherein said flagpole has a transverse pole cross section equal to a transverse seat cross section.

3. The flagpole adapter according to claim 1, wherein the adapter seat is cylindrical.

4. The flagpole adapter according to claim 1, wherein the adapter seat has an outer diameter equal to an outer diameter of said flagpole end.

5. The flagpole adapter according to claim 1, wherein the adapter seat has an outer diameter smaller than an inner diameter of the adapter mouth.

6. The flagpole adapter according to claim 1 wherein the rotation assembly is disposed within the adapter mouth.

7. The flagpole adapter according to claim 1, wherein the rotation assembly comprises an adapter having an adapter seat end and an adapter mouth end, the adapter seat end being positioned adjacent the adapter seat and the adapter mouth end being positioned adjacent the adapter mouth.

8. The flagpole adapter according to claim 7, wherein the adapter mouth end is configured to receive the flagpole end, the flagpole end being supportable by the adapter seat end.

9. The flagpole adapter according to claim 7, wherein the rotation assembly comprises a bearing mechanism positioned intermediate the adapter body and the adapter configured to enable rotation of the adapter within the adapter body.

10. The flagpole adapter according to claim 1, wherein the rotation assembly defines an axis of rotation for the flagpole.

11. The flagpole adapter according to claim 10, wherein the adapter comprises a plurality of circumferentially spaced support portions extending radially to said axis of rotation, configured to radially engage and support the flagpole end.

12. The flagpole adapter according to claim 11, wherein the support portions extend from the adapter mouth end to the adapter seat end.

13. The flagpole adapter according to claim 11, wherein the support portions are integrally formed with the adapter seat end.

14. The flagpole adapter according to claim 10, wherein the support portions each comprise an inner support surface, the inner support surfaces of the support portions being configured to support an outer pole surface of the flagpole end.

15. The flagpole adapter according to claim 14, wherein the outer pole surface of the flagpole end is circular, the inner support surfaces being radiused to correspondingly mate with the outer pole surface.

16. The flagpole adapter according to claim 15, wherein the inner support surfaces each comprise a uniform radius, the uniform radii of the inner support surfaces equaling a flagpole end radius extending transversely relative to the flagpole axis, optionally, equaling radius extending transversely relative to the flagpole axis.

17. The flagpole adapter according to claim 7, wherein the adapter comprises at least one pole-locking mechanism.

18. The flagpole adapter according to claim 17, wherein the adapter comprises a plurality of circumferentially spaced pole-locking mechanisms.

19. The flagpole adapter according to claim 18, wherein said pole-locking mechanisms are alternatingly positioned intermediate the circumferentially spaced support portions.

20. A flagpole adapter kit for mounting a flagpole and enabling the flagpole as mounted to freely rotate about a flagpole axis, the flagpole adapter kit comprising:
a flagpole adapter according to claim 1, and
an adapter mounting mechanism being configured to anchor the adapter body.
